(19) United States
(12) Patent Application Publication
(10) Pub. No.: US 2025/0013069 A1
(43) Pub. Date: Jan. 9, 2025

(54) LIGHT FIELD DISPLAY DEVICE AND HEAD-MOUNTED DISPLAY

(71) Applicant: Masuyuki OTA, Hakusan-shi (JP)

(72) Inventor: Masuyuki OTA, Hakusan-shi (JP)

(21) Appl. No.: 18/763,979

(22) Filed: Jul. 3, 2024

Related U.S. Application Data
(60) Provisional application No. 63/511,687, filed on Jul. 3, 2023.

(51) Int. Cl. G02B 30/31; G02B 27/00

(52) U.S. Cl. CPC G02B 30/31; G02B 27/0093

(57) ABSTRACT

The present invention includes a three-dimensional (3D) image display device and a head-mounted display featuring a light-field image display comprising a display panel with a group of element pixels composed of multiple pixels displaying light field information, and a light shutter array panel capable of forming an aperture by opening and closing multiple light shutters. In the present invention, to address vergence-accommodation conflict (VAC), reduce crosstalk, improve viewing angles, and enhance 3D resolution, the light-field image display has a light field ray group with multiple radiation angles formed by the element pixel group and the aperture, wherein the resolution of the radiation angles of the light field ray group is 0.3° or less. It further comprises a padding pixel group with one or more pixels not displaying light field information around the element pixel group, and the light field ray group is output only within a central viewing angle range, while a two-dimensional image is output in angular ranges outside the central viewing angle.

### RELATED APPLICATIONS

This application claims benefit of and priority to U.S. Provisional Application Ser. No. 63/511,687 filed Jul. 3, 2023, entitled Light Shutter, Ligh Field Display And Head-Mounted Display, which is hereby incorporated herein by reference in its entirety.

### TECHNICAL FIELD

The present invention relates to a light-field image display device provided with an optical modulator comprising multiple electro-optical shutters and display technology therefore. More particularly a light-field display device used in a head-mounted display.

### BACKGROUND OF THE INVENTION

Head-Mounted Displays (HMDs) are three-dimensional imaging devices that provide experiences in Virtual Reality (VR), Augmented Reality (AR), Mixed Reality (MR), and spatial computing. They are worn on the head like goggles or glasses. HMDs incorporate displays, motion sensors, cameras, and audio systems internally. The display, positioned close to the eyes, forms a stereoscopic three-dimensional images (3D images), offering an immersive experience to the user. While wearing an HMD, users can view real-world objects through the device while simultaneously overlaying virtual objects.

In recent years, significant advancements in technology have led to improvements in the display resolution, field of view, tracking accuracy, and comfort of HMDs. These improvements have expanded the applications of HMDs beyond gaming and entertainment to various other fields such as education, healthcare, academic research, training, automotive, architecture, design, tourism, and shopping in the metaverse (digital commerce, digital advertising, virtual goods, avatar market), among others.

Particularly promising is the industrial application of HMDs as visual devices for remote operation systems in scenarios where the objects being manipulated are located far from the operator, such as in surgical robots, collaborative robots in factories, high-altitude work in construction sites, and disaster areas. Remote operation systems involve controlling robots or drones placed in remote locations from a different site, and HMDs play a crucial role in providing visual feedback to operators.

For example, Patent Document 1, Japanese published unexamined patent application No. 2014-004656 discloses a remote operation system where images captured by imaging devices deployed on-site are transmitted through wireless or wired networks and displayed on HMDs worn by operators, enabling them to observe and perform tasks on objects remotely.

The current mainstream Head-Mounted Displays (HMDs) primarily use binocular disparity, showing slightly different images to the left and right eyes. This allows users to perceive the depth of objects through convergence and divergence of both eyes, a method known as binocular parallax. However, a significant issue with this parallax method HMD is the inconsistency between the depth perceived through the monocular accommodation of the crystalline lens (referred to as focal distance) and the depth perceived through binocular disparity (referred to as convergence distance). This inconsistency leads to a conflict between focus adjustment and convergence/divergence movements, known as Vergence-Accommodation Conflict (VAC).

The principle of VAC generation is shown in FIGS. 27A and 27B. As shown in FIG. 27B, in the parallax method, while focusing on the virtually displayed screen that is magnified by the eyepiece lens, convergence is induced in the user by parallax. Here, in the parallax method, the focal distance remains constant, while only the convergence distance changes. However, as shown in FIG. 27A, when looking at real objects, the focal distance and convergence distance always match, and physiologically, after convergence adjustment, a reflex of focus adjustment (the matching of focal distance and convergence distance) occurs, leading to stable vision at the fixation point. But in the parallax method, this focus adjustment reflex contradicts, resulting in VAC.

This VAC makes it difficult to focus on objects and can cause physiological adverse effects due to the reflex of accommodation leading to headaches and eye fatigue as disclosed in Non-Patent Document 1, G. Kramida, “Resolving the Vergence-Accommodation Conflict in Head-Mounted Displays,” in IEEE Transactions on Visualization and Computer Graphics, vol. 22, no. 7, pp. 1912-1931 July 1, 2016, doi: 10.1109/TVCG.2015.2473855. and Non-Patent Document 2, Hoffman DM, Girshick AR, Akeley K, Banks MS. Vergence-accommodation conflicts hinder visual performance and cause visual fatigue. J Vis., Mar. 28, 2008; 8(3):33.1-30. doi: 10.1167/8.3.33. PMID: 18484839; PMCID: PMC2879326.

It is also one of the main causes of motion sickness specific to HMDs (also known as VR sickness) making prolonged use of HMDs challenging as disclosed in Non-Patent Document 3, Ben D. Lawson. et. al., “Editorial: Cybersickness in VirtualReality and Augmented Reality”, October 2021, Frontiers in Virtual Reality 2:759682, DOI:10.3389/frvir.2021.759682.

Furthermore, due to the potential for permanent adverse effects on vision, such as diplopia (double vision), it is recommended that children under the age of six avoid using HMDs as disclosed in Non-Patent Document 4, “3D technologies and eyesight: use not recommended for children under the age of six, use in moderation for those under the age of 13”, Anses, Nov. 6, 2014.

Therefore, unlike applications such as games and entertainment where images are often viewed from a relatively far distance, applications that require detailed observation of complex three-dimensional structures or intricate work while viewing them involve spending more time staring at objects within a close visual distance space of 1 meter or less. However, the difficulty of gazing due to the aforementioned VAC poses significant challenges to workability and makes it difficult to perform tasks over long periods due to eye strain and motion sickness. For example, the visual distance for everyday tasks is generally about 30-50 cm, and the appropriate working range within reach is generally up to about 75 cm. Therefore, particularly in applications that require detailed observation and work, the use of conventional HMDs with the parallax method is made difficult.

As a solution to the VAC, new 3D display methods have been developed, such as variable focus, multi-depth planes, holographic, and Light Field Displays (LFDs, also known as Integral Imaging Displays). Among these, LFDs are primarily developed for glasses-free 3D viewing, but recently, LFD-based Head-Mounted Displays (LF-HMDs) have been developed as a measure to improve VAC as disclosed in Patent Document 2, Japanese published unexamined patent application No. 2023-004538 and Non-Patent Document 5, Yasutaka, Maeda et al., “Improvement of Field of View in Light-Field Head-Mounted Display by Displacing Elemental Images”, Proceedings of the International Display Workshops Volume 27, PRJ7/AIS7-4.

LFDs finely control the direction and intensity of light to reproduce light information from multiple viewpoints, thereby reproducing rays similar to those from real 3D objects. This enables the perception of 3D images with volume, similar to objects seen in the real world. Consequently, the user's focus and convergence adjustments always match, allowing the perception of natural 3D images similar to real-world 3D objects, thus resolving VAC.

There are four types of LFDs:

Parallax Barrier Method: This method uses physical barriers, such as parallax barriers, to form numerous images with different viewpoints, creating continuous parallax. Conventional stereoscopic methods also fall into this category, forming only two images directed at the left and right eyes. The viewing angle is limited by the barrier and the corresponding pixel arrangement, and visual noise such as crosstalk, which displays unnecessary image information, is likely to occur. Additionally, the resolution significantly decreases.

Microlens Array Method: This method uses a special microlens array to form numerous images with different viewpoints. By arranging multiple display pixels for each lens element, each displaying light information at different angles, an LF is formed. This method is relatively simple and easy to implement, and is widely used in glasses-free 3D displays. However, due to the principle, it is difficult to increase the density of the origins of the LF output, requiring high-resolution display panels with a large number of pixels. To achieve high-resolution 3D images with this method, high-resolution resolution display panels with pixel counts exceeding 8K are required as disclosed in Non-Patent Document 6, JDI, May 17, 2018 retrieved from https://www.j-display.com/news/release/detail/20180517000000.html.

Multi-layer Method (also known as Optical Shutter Method): This method uses multiple transparent displays or optical shutters stacked to give directionality to the transmitted light, controlling the emission direction to form numerous images with different viewpoints. With this method, time-division driving can maintain the same resolution as the original display's resolution. It can also switch between 3D display using LF and 2D display as disclosed in Non-Patent Document 7, Choi, H. et. al., (2006), “A 3D/2D convertible display with pinhole array on a LC panel”, 1361-1364, 13th International Display Workshops. However, there are limits to the number of LFs that can be generated due to the processing capacity of the graphics board handling the drawing data and the response speed of the display or optical switch. Additionally, strong crosstalk occurs with this method, preventing practical image quality from being achieved as disclosed in Non-Patent Document 8, Gordon Wetzstein et. al., “Tensor displays: compressive light field synthesis using multilayer displays with directional backlighting”, ACM Transactions on Graphics Volume 31 (4), Jul. 1, 2012, https://doi.org/10.1145/2185520.2185576.

Diffusion Screen Method: This method uses multiple projectors to project images from different viewpoints as directional rays onto a diffusion screen. By appropriately expanding each ray passing through the screen according to the ray interval, a dense ray group without gaps is formed, reproducing the 3D image. This method allows for an increase in the pixel count of multiview images and an enlargement of the screen size, offering advantages for high-resolution and large-screen 3D images. However, due to the large system configuration, it is impossible to use this method for HMDs or direct-view flat panel displays, and thus it is excluded from the scope of this invention.

Among these, the present invention relates to the Multi-layer Method of LFDs.

To eliminate VAC by using LFD, it is necessary to have a sufficient radiating angle width β and angular resolution Δβ (hereinafter referred to as Δβ) of LF rays to satisfy human visual characteristics.

FIG. 28 shows the comfortable range 401 where VAC is not felt as disclosed in Non-patent document 9, Takashi Shibata et. al,, “The zone of comfort: Predicting visual discomfort with stereo displays.” J Vis., Jul. 21, 2011; 11(8):11. doi: 10.1167/11.8.11. PMID: 21778252; PMCID: PMC3369815.

The vertical axis represents the focal distance FD, that is, the distance at which focus is adjusted on an object, and the horizontal axis represents the vergence distance VD, that is, the distance at which vergence is adjusted on an object. Both the focal distance FD and the vergence distance VD are shown in units of D (diopters), where D is the reciprocal of the distance.

Specifically, the comfortable range without VAC, that is, the allowable range of vergence distance VD for a single focal distance FD, is approximately a difference of 1.1 to 1.3 D, as shown in FIG. 28. Table 1 shows the focal distance settings that do not cause VAC, the permissible convergence distance (VD) range, and the required emission angle width (β) (Viewing distance L: 30 cm to ∞).

TABLE 1

| | | | Required Emission | |
|---|---|---|---|---|
| | | | Angle Half Width β/2 | |
| Focal | | Permissible | | discriminative field |
| Diastance | | Convergence | | (including |
| Settings | | Distance | Fovia | the parafovea) |
| FD1 | 2.8D (36 cm) | 3.3D (30 cm) | 1.4° | 3.2° |
| | | ~2.1D (48 cm) | (1.3°~1.5°) | (3.0°~3.4º) |
| FD2 | 1.5D (67 cm) | 2.1D (48 cm) | 1.1° | 2.9° |
| | | ~1.0D (100 cm) | (1.0°~1.3°) | (2.8°~3.0°) |
| FD3 | 0.4D (250 cm) | 1.0D (100 cm) | 0.8° | 2.6° |
| | | ~OD (∞) | (0.7°~1.0°) | (2.5°~2.8°) |

As shown in Table 1, specifically, when the focal distance FD is set for a viewing distance L of about 36 cm (2.8D), the range of vergence distance VD that causes no discomfort from VAC is approximately 30 cm (3.3D) to 48 cm (2.1D). Similarly, when the focal distance FD is set for a viewing distance L of about 67 cm (1.5D), the range of vergence distance VD is approximately 48 cm (2.1D) to 100 cm (1.0D), and when the focal distance FD is set for a viewing distance L of 250 cm (0.4D), the range of vergence distance VD is approximately 1.0D (1.0 m) to OD (∞). In other words, if it is possible to realize the angle width of LF ray radiation β for at least these three focal distances FD1, FD2, FD3, or smaller steps of focal distance FD, then there will be no discomfort from VAC at viewing distances from 30 cm to infinity.

FIG. 29 shows the relationship between the focal distance FD (viewing distance L) and the required angle width of radiation βf (for longer focal distances) and βn (for shorter focal distances) within the central foveal field of view. Additionally, FIG. 30 shows the relationship between the focal distance FD and the required LF radiation angle width β for monocular vision. Generally, this can be expressed by the following equation 1 and equation 2.

$$W = 2 FD \cdot tan ( {θ}_{f} / 2 ) \qquad ( 1 )$$

$$β = 2 {tan}^{- 1} \{ \frac{1}{2 FD} ( W + {R}_{C} ) \} = 2 {tan}^{- 1} \{ tan ( {θ}_{f} / 2 ) + \frac{{R}_{C}}{2 FD} \} \qquad ( 2 )$$

θ_{f}: Fovea angle range (or discriminative field)
R_{C}: Diameter of the crystalline lens
W: Region of the image viewed by the fovea (or discriminative field).

As shown in FIG. 30, a wider radiation angle width β is required at closer focal distances FD, particularly becoming significantly larger when the focal distance FD is within 1 meter. This is the reason why VAC is more easily perceived, especially within 1 meter.

Furthermore, from Table 1, it can be observed that the difference in the required LF radiation angle width β for each of the focal distances FD1, FD2, and FD3 is 0.3°. Therefore, the radiation angle resolution Δβ, which serves as the unit for incrementing LF radiation angle width β, needs to be 0.3° or less (Δβ≤0.3°).

As shown in FIG. 30, a wider radiation angle width β is required at closer focal distances FD, particularly becoming significantly larger when the focal distance FD is within 1 meter. This is the reason why VAC is more easily perceived, especially within 1 meter.

Furthermore, from Table 1, it can be observed that the difference in the required LF radiation angle width β for each of the focal distances FD1, FD2, and FD3 is 0.3°. Therefore, the radiation angle resolution Δβ, which serves as the unit for incrementing LF radiation angle width β, needs to be 0.3° or less (Δβ≤0.3°).

VAC begins to be perceived from focal distances FD of 0.4 D (2.5 meters) or less, and it modestly appears especially at close viewing distances within 1 m. Therefore, it is essential to meet this condition when the focal distance FD is less than 1 meter.

However, in conventional LFDs, only the diffusion screen method has been able to achieve this, with a Δβ of 0.235, as disclosed in Non-Patent Document 10, S. Iwasawa, et. al., “REI: an Automultiscopic Projection Display”, Proc. of 3DSA 2013, Selected Paper 1 (2013).

Lens array methods and multi-layer methods have not been able to realize a Δβ of 0.3° or less. The Δβ for these methods is generally around 1°-2°, with the smallest being 0.6° by using 8K display as disclosed in Non-Patent Document 11, Okaichi. et. al., The Institute of Image Information and Television Engineers, Winter, 23D-3 (2018).

The primary reason for this is the trade-off with the field of view (FOV: Field Of View). In LFDs, the field of view FOV, the number of LF rays N (in one azimuth direction), and Δβ have the following relationship:

$$tan Δβ = \frac{2}{N - 1} \cdot tan ( \frac{FOV}{2} ) \qquad ( 3 )$$

When there are limitations on the number of LF rays N, enlarging the field of view FOV and reducing the LF radiation angle resolution Δβ become completely trade-offs.

Secondly, when attempting to reduce the emission angular resolution Δβ, crosstalk (or artifacts) is more likely to occur. This is because, in an LFD, reducing the emission angle of the LF rays makes it more susceptible to the influence of unnecessary information emitted from neighboring pixel groups. This interference affects the original LF rays and overlaps with the display, causing crosstalk. The LF emission angular resolution Δβ required to avoid crosstalk is similarly expressed by the following formula.

$$tan Δβ > \frac{1}{N - 1} \cdot tan ( \frac{FOV}{2} ) \qquad ( 4 )$$

Thus, avoiding crosstalk and ensuring the FOV, along with reducing the LF emission angular resolution Δβ, are in a complete trade-off relationship. In conventional LFDs, it has been impossible to reduce the LF emission angular resolution Δβ to secure a certain FOV and avoid crosstalk.

To resolve this, it is necessary to increase the number of LF rays N, i.e., the number of pixel elements that form the basis of the LF rays. However, increasing the number of pixel groups enlarges the area of one pixel group in the total number of pixels of the display, reducing the number of pixel groups. Consequently, the number of origins for LF rays decreases, resulting in a significant reduction in 3D resolution.

Therefore, it becomes necessary to use high-definition display panels with a large number of pixels. However, the advancement in display panel resolution is limited by the miniaturization process of the manufacturing process and increases manufacturing costs, reaching its limits. In the case of multi-layer methods, it is possible to increase the effective number of LF ray origins by increasing the time division number of the time-division drive. However, the higher driving frequency required to increase the time division number is also reaching its limits, making further improvements unfeasible.

Even if ultra-high-definition displays are created or higher driving frequencies are achieved, the rendering load increases significantly, necessitating the use of an extremely high-performance and expensive graphics board. Therefore, the cost of displays and an graphics board becomes extremely high, making practical implementation very difficult.

It should be noted that while it is possible to achieve this with diffusion screen types due to their principle of overlaying images on the screen to enhance resolution, as mentioned earlier, the size of such systems makes it impossible to implement them as HMDs or flat-panel displays. Therefore, they are not the focus of the present invention.

### BRIEF SUMMARY OF THE INVENTION

The objectives of the present invention are as follows:

Firstly, to completely eliminate the Visual Accommodation Conflict (VAC) in 3D displays. This is achieved by ensuring that the Light Field (LF) ray group in a Light Field Display (LFD) has a radiation angle resolution of Δβ≤0.3°, particularly in shutter-type LFDs that can be implemented as Head-Mounted Displays (HMDs) or flat panel displays.

At the same time, to provide an LFD that expands the field of view and eliminates crosstalk.

Furthermore, to enhance the LF beam origin density and provide an LFD with high 3D resolution, while meeting the above criteria.

Another objective is to provide a control method for LFDs that can accommodate high-resolution 3D images and fast-moving video images simultaneously.

Additionally, to reduce rendering load to enable realization with a low-cost, low-power graphic board.

Moreover, to solve new issues of brightness uniformity and display quality that arise.

Lastly, the invention aims to provide a high-speed response liquid crystal optical shutter to achieve high contrast.

By these means, to enable the perception of a realistic presence as if viewing the actual object in front of user's eyes, and to obtain natural and high-fidelity 3D images and 3D spatial cognition across the entire field of view without feeling fatigued even after long periods of viewing.

Along with this, to realize an LFD and LF-HMD that are overall superior in quality and cost-performance, with a reduced rendering load. Particularly, to provide an LFD, and the HMDs and systems using it, that are suitable for applications requiring observation of fine three-dimensional structures, such as remote operation, medical, educational, and design purposes.

In order to accomplish the above objects, a LFD device comprises a display panel having at least one group of elemental pixels for displaying light-field information and an optical shutter array panel capable of forming at least one aperture through the opening and closing of multiple optical shutters, and the combination of the elemental pixel group and the aperture forms a light-field ray group with multiple emission angles, with an angular resolution of 0.3° or less.

The device comprises at least one group of padding pixels, which do not display light-field information, around the periphery of the elemental pixel group, and the area of the aperture is larger than the area of one pixel of the elemental pixels.

Further, a HMD is equipped with an eye-tracking sensor, which determines the user's point of gaze and the central field of view angle range identified from the gaze point. The light field ray group is outputted only within the central field of view angle range, and a 2D image is outputted in the angle ranges outside of the central field of view.

Also, the entire display area is divided into a first display area, which is projected by the central field of view, and a second display area, which covers the rest. The light field ray group is outputted only from the first display area, while a 2D image is outputted from the second display area. In addition, the brightness of the first display area is higher than that of the second display area, and the display resolution of the 2D image is lower than the original resolution of the display panel.

Furthermore, the light shutter array panel consists of a liquid crystal cell made up of a pair of opposing substrates with a liquid crystal layer sandwiched between them, a pair of polarizing plates, and a group of electrodes that can switch and apply a horizontal electric field and a vertical electric field to the liquid crystal layer relative to the pair of substrates. The electric field applied by the group of electrodes partially changes the alignment state of the liquid crystal layer, allowing the opening and closing of each of the multiple light shutters to be switched, thereby varying the aperture.

Additionally, it includes means for estimating the user's viewing distance L using an eye-tracking sensor, and means for estimating the degree of motion M of the image relative to the user's eyes from the eye-tracking sensor data and input image data. When the viewing distance L is greater than the threshold L_{TH} and/or the degree of motion M is greater than the threshold M_{TH}, the entire display area switches to a 2D image display.

Moreover, based on the viewing distance L and the degree of motion M, the number of output light field rays, absolute angle, radiation angle width, divergence angle, position of the origin, and density of the origin are changed for each display frame.

Also, the input video data is processed using a 2D convolutional neural network to generate the display images for the display panel and the aperture patterns for the light shutter array panel for each display frame.

By means of the present invention, it is possible to eliminate VAC while achieving extremely high 3D resolution and display quality. As a result, highly natural and realistic 3D images, as if viewing real objects right before your eyes, can be realized. The sense of reality in 3D images within the range of less than 1 meter is extremely high, enabling intuitive understanding of fine and complex 3D structures and textures.

Furthermore, a comfortable HMD that can be used for extended periods without physiological side effects or discomfort, safe even for children, can be achieved. In addition, it excels in recognizing fast-moving videos and grasping wide 3D spaces, providing a high-resolution 3D image space throughout the entire field of view.

Moreover, the rendering load of high-resolution 3D images can be significantly reduced, allowing for the realization of a low-cost 3D display system. Additionally, it can utilize conventional format video content and easily create new content, achieving a high-quality 3D display system.

These features make it possible to realize the optimal HMD for many applications, such as remote operations, alternate reality requiring high realism in personal spaces, digital therapy, and many other uses.

### BRIEF DESCRIPTION OF THE DRAWINGS

FIG. 1 is a basic configuration diagram of an HMD using the light shutter type LFD of the present invention.

FIGS. 2A and 2B are diagrams showing the display principle of the light shutter type LFD of the present invention.

FIG. 3 is a diagram showing the optical system of the light shutter type LFD of the present invention.

FIG. 4 is an example in which nine light field rays are configured by a group of 3×3 pixels for one aperture.

FIG. 5 is an example in which a group of 3×3 pixels for one aperture drives a 3×3 aperture in time division of 9.

FIG. 6 is a diagram showing the relationship between the pixels of the display panel and the apertures of the light shutter panel.

FIGS. 7A, 7B and 7C are diagrams showing the method of controlling the absolute angle α of the light field rays.

FIGS. 8A, 8B and 8C are diagrams showing the method of controlling the number of LF output rays N and the radiation angle width β of the light field rays.

FIGS. 9A, 9B and 9C are diagrams showing the method of controlling the divergence angle γ of the light flux of the light field rays.

FIG. 10 is a diagram showing the relationship between the time constant T of the response speed and the dynamic contrast ratio.

FIGS. 11A and 11B are diagrams showing the arrangement of the elemental pixel groups, apertures and padding pixels of the conventional light shutter method and the present invention.

FIG. 12 is a diagram showing the relationship between the setting method of the padding pixels and the aperture pitch of the apertures in response to crosstalk occurrence.

FIG. 13 is a diagram showing the assignment of each frame with time-division driving of LF for the present invention.

FIGS. 14A and 14B are diagrams showing the shapes of the square element pixel groups of Embodiment 1 to 3 and the diamond-shaped element pixel groups of Embodiment 4, and the arrangement examples of each pixel group in the image area.

FIG. 15 is a diagram showing the concept of CLF (Condensed Light-Field) in Embodiment 5.

FIGS. 16A and 16B are diagrams showing the difference between the LF ray density (spatial frequency) in the depth direction (viewing distance direction) of the conventional LFD and that of the present invention.

FIG. 17 is a diagram showing the assignment of each frame with time-division driving of LF3D and 2D display for Embodiment 5 to 7.

FIG. 18 is a diagram showing the relationship between the visual angle and visual acuity.

FIGS. 19A, 19B and 19C are diagrams showing the overview of the display method of the central field of view image area of Embodiment 8.

FIGS. 20A, 20B and 20C are diagrams showing the overview of the display method of the central area and the boundary area of Embodiment 9.

FIGS. 21A, 21B, 21C and 21D are diagrams showing the state change of the light field rays from the central field of view image area to 2D image area.

FIGS. 22A and 22B are diagrams showing the configuration and optical operating state of the light shutter panel of Embodiment 10.

FIGS. 23A and 22B are diagrams showing the cross-section and electrical driving state of the dual-field type liquid crystal cell of Embodiment 10.

FIG. 24 is a diagram showing the pixel circuit and electrode arrangement (4 TFT, 4 signal line configuration) of Embodiment 10.

FIG. 25 is a diagram showing the system configuration of the determiner of Embodiment 11 to 13.

FIG. 26 is a flowchart showing the switching of LF 3D images and 2D parallax images by the determiner of Embodiment 11 to 13.

FIGS. 27A and 27B are diagrams showing the principle of VAC occurrence.

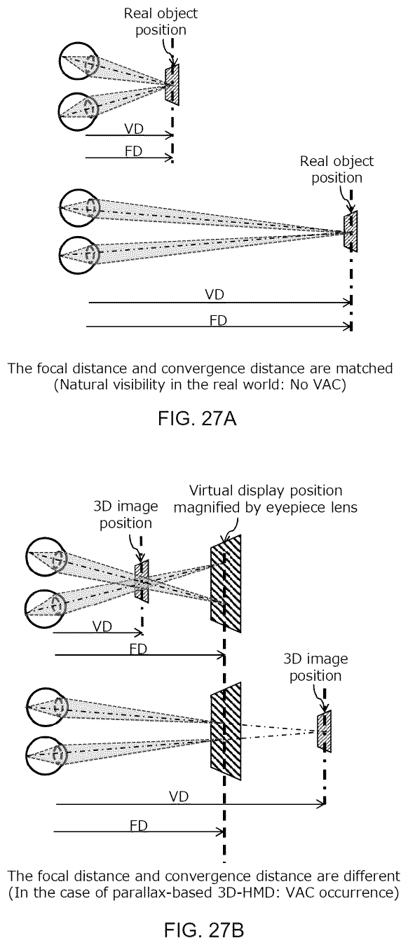

FIG. 28 is a diagram showing the zone of comfort without VAC for the difference between focal distance and convergence distance.

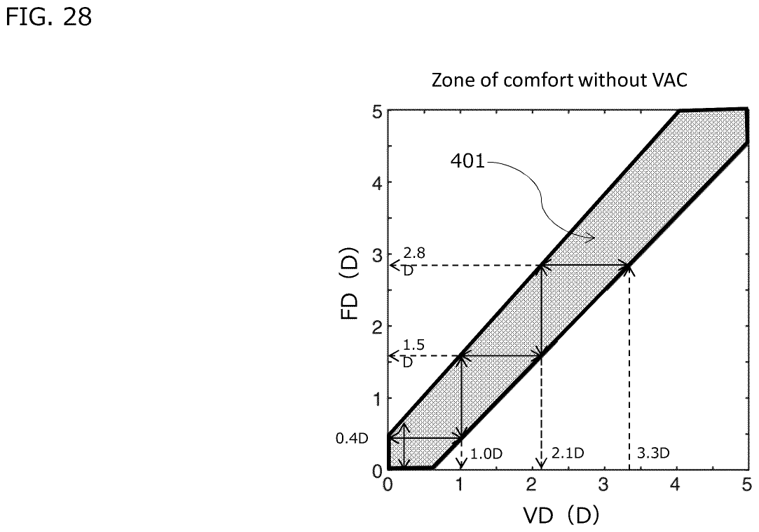

FIGS. 29A and 29B are diagrams showing the relationship between focal length (viewing distance) and the necessary radiation angle width.

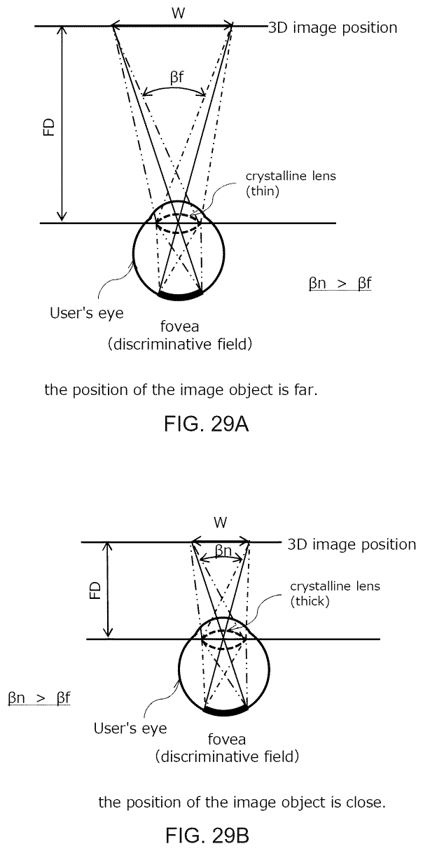

FIG. 30 is a diagram showing the relationship between focal length (viewing distance) and the necessary radiation angle width βE for proper focus adjustment in monocular vision.

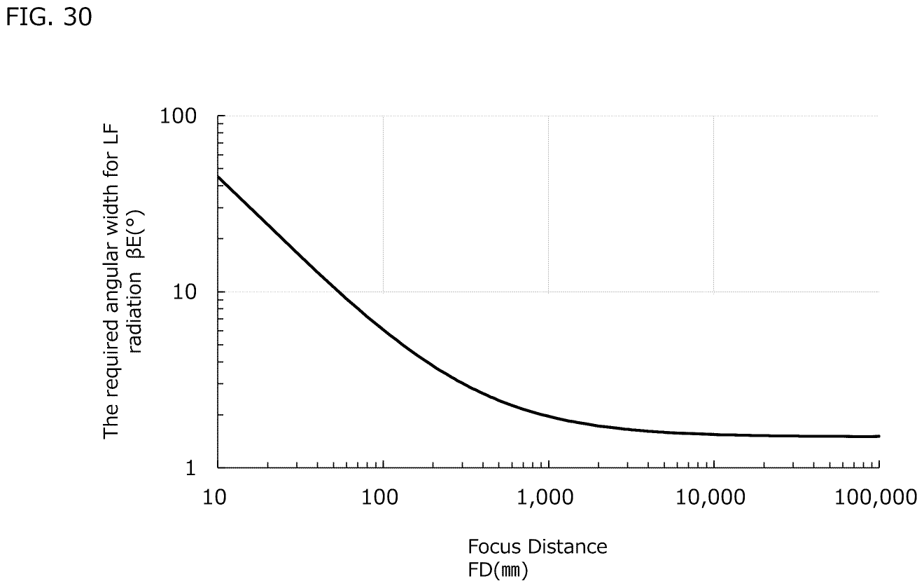

### DETAILED DESCRIPTION

Embodiments of the present invention will hereinafter be described with the reference to drawings. In the embodiments, a technique in which the light field display of the present invention and its image display technology are applied to head-mounted displays will be described.

### Embodiment 1

First, a Head-Mounted Display used for the present invention is described below.

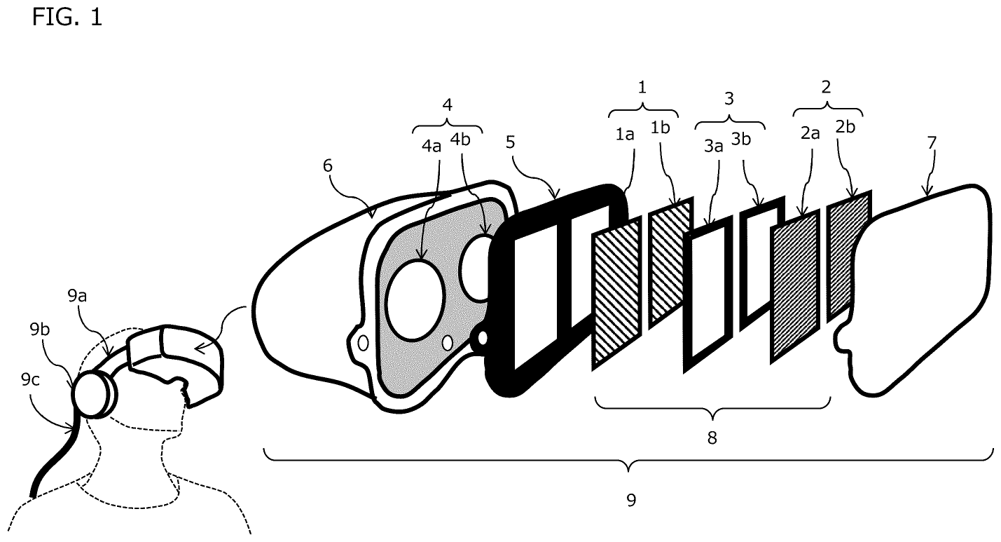

FIG. 1 shows the configuration of the HMD 9 equipped with the LFD 8 of the present invention. In this embodiment, the HMD 9 is constructed with a casing 6, outer cover 7, two LF image display panels 2 for the right eye 2a and the left eye 2b, two light shutter panels 1 for the right eye 1a and the left eye 1b, and spacers 3 (3a, 3b) to overlay and bond them together, forming the LFD 8. It also includes a drive circuit (not shown) to drive these components in coordination, two eyepiece lenses 4 for the right eye 4a and the left eye 4b, and spacers 5 to maintain the distance between the LFD and the lenses, comprising the optical system. Additionally, it includes a motion sensor (not shown) to detect head movement, an eye-tracking sensor (not shown) to track the gaze, and a camera (not shown) to capture the external environment, all enclosed within the HMD 9. Note that the head motion sensor and the eye-tracking sensor are repurposed from sensors used in currently available VR headsets, so detailed descriptions are omitted.

As shown in FIG. 1, the HMD 9 is connected to an external PC or controller via a connection cable 9c and is worn on the head with a fixation band 9a. It may also be integrally formed with audio speakers 9b.

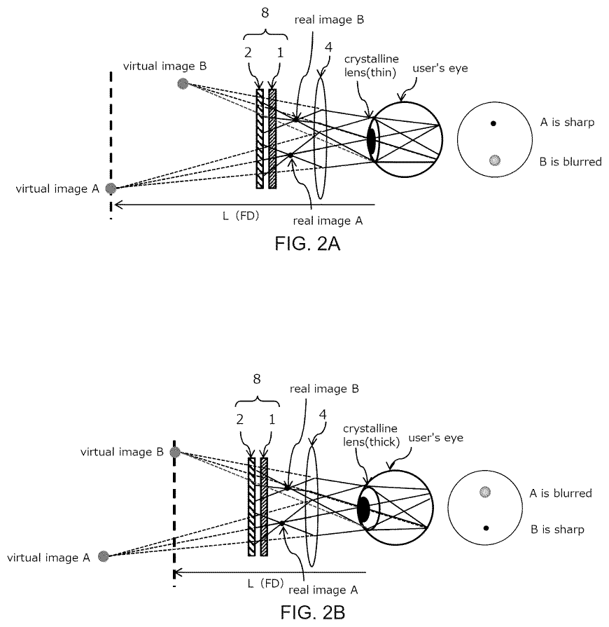

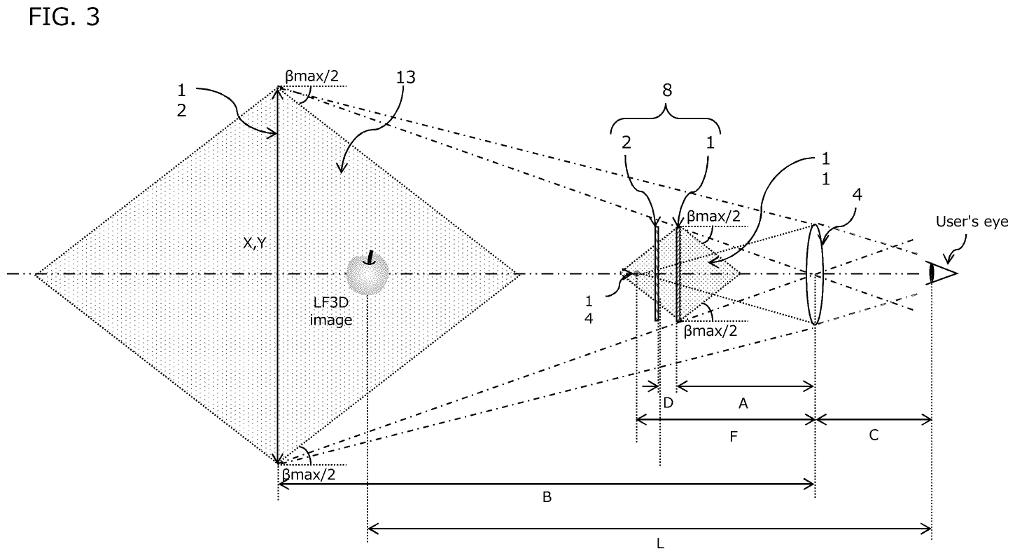

FIGS. 2A and 2B illustrate the display principle of the light shutter method LFD of the present invention. In FIG. 2A, when the focus is aligned to virtual image A (far viewing distance), and in FIG. 2B, when the focus is aligned to virtual image B (near viewing distance). FIG. 3 shows a conceptual diagram of its optical system. Table 2 presents the specifications of each component of the HMD of the present invention.

Table 2 presents the specifications of each component of the HMD of the present invention.

TABLE 2

| | | Embodiment 1 and 2 | Embodiment 3 and 4 | Embodiment 5 to 9 | Embodiment 10 to 13 |
|---|---|---|---|---|---|
| Displat Panel | | Active Matrix Type | ← | ← | Active Matrix Type |
| | | Color LCD | | | Color OLED |
| Optical Shutter Array Panel | | Active Matrix Type | ← | ← | High-Speed Binary Optical |
| | | Color LCD | | | Shutter Array |
| Optical | Focal Length of | 66 mm | ← | 46 mm | ← |
| | Eyepiece Lens F | (FOV = 44° setting) | | (FOV = 60° setting) | |
| System | Display Panel- | 6.9 mm | 10.3 mm | ← | ← |
| | Optical Shutter Array | (Hollow) | (Acrylic Plate + High | | |
| | D | | Refractive Index Resin) | | |
| | LFD-Eyepiece Lens | 61.5 mm | ← | 44.2 mm | ← |
| | A | | | (FOV = 60° setting) | |
| | Virtual Display Size | 939 mm × 939 mm | ← | 1325 mm × 1325 mm | ← |
| | (H: Horizontal)× | | | | |
| | (V: Vertical) | | | | |

Display Panel
Display Area | 51.8 mm × 51.8 mm | ← | ← | ←
Number of Pixels | 1440 (H) × 1440 (V) | ← | ← | ←
Pixel Size | 36 μm (H) × 36 μm (V) | ← | ← | ←
RGB Arrangement | Stripe | ← | ← | ←
Optical Shutter Array Panel
Shutter Area | 51.8 mm × 51.8 mm | ← | ← | ←
Number of Openings | 1440 (H) × 1440 (V) | ← | ← | ←
Opening Size | 36 μm (H) × 36 μm (V) | ← | ← | ←
Optical System
Size of Eyepiece Lens | Diameter 40 mm | ← | ← | ←
Eyepiece Lens-Pupil C | 20 mm | ← | ← | ←
Pupil-Virtual Image Display Surface DIstance B | 1130 mm | ← | ← | ←

As shown in FIGS. 2A and 2B, real images A and B are displayed on the front of the LFD 8. The user can view the virtual images A and B through the eyepiece lens 4, which are magnified in position and distance. At this time, depending on which of the virtual images A and B, which have different distances in the depth direction (viewing distance direction), the user focuses on, one can be seen in focus while the other appears blurred due to being out of focus. Note that the display principle of the LFD is omitted here as it is a common one.

In this embodiment, as shown in FIG. 3, the LFD 8 sets so that the virtual image display surface 12 of the virtual 3D image generated by the LFD 8 appears at a position 1.13 m (the distance B) from the user's pupils, with dimensions of 939 mm×939 mm. The focal length F of the eyepiece lens, the distance A between the eyepiece lens 4 and the LFD 8, and the distance C between the eyepiece lens 4 and the pupils are set as indicated in Table 2. The area denoted by 11 represents the display space of the LF 3D images generated by the LFD 8, while, the area denoted by 13 represents the enlarged 3D spatial region perceived by the user, which is achieved through the magnification effect of the eyepiece lens 4.

L indicates the viewing distance between the 3D image generated by the light field and the user's pupil, and X and Y represent the size of the virtual image display plane (where “X” denotes the horizontal direction, and “Y” denotes the vertical direction).

The magnification ratio m of the virtual image is as follows.

$$m = \vert \frac{B}{A} \vert = \vert \frac{F}{A - F} \vert = \vert \frac{B - F}{F} \vert \qquad ( 5 )$$

In the LF-HMD of the present invention, the virtual image display surface 12 serves as the LF light ray origins.

The LFD 8 is assembled using a spacer 3 to ensure that the pixel pitch distance D between the display panel 2 and the light shutter panel 1 is 6.9 mm. In this embodiment, the spacer 3 is of the hollow type.

Furthermore, the manufacturing method and driving method of the display panel 2 and the light shutter panel 1 in this embodiment are similar to a common one, and detailed descriptions are omitted in this specification except for the following.

As for the display panel 2, an active matrix type color liquid crystal display panel with high-speed response is used. The response times of the display panel are as follows: the response time T_{ON} from off (brightness 0%) to on (brightness 95%) is 0.5 ms, and the response time T_{OFF} from on (brightness 100%) to off (brightness 5%) is 1.5 ms.

Additionally, the light shutter panel 1 utilizes an active matrix type monochrome panel liquid crystal display panel without the color filter. Like the display panel, the response time T_{ON} is 0.5 ms, and the response time T_{OFF} is 1.5 ms.

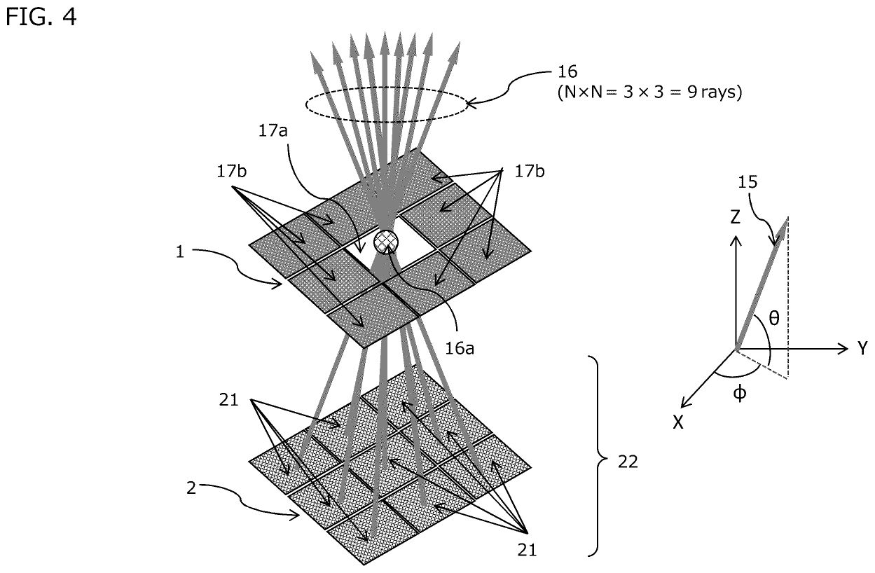

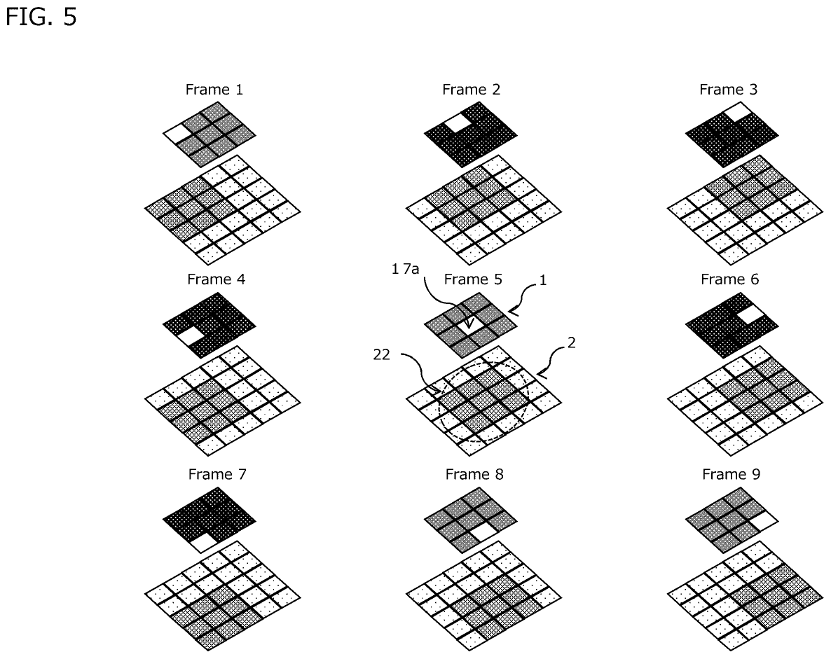

FIGS. 4 and 5 illustrate the formation method of a conventional multi-layer LFD. In the figures, the number 21 represents each pixel of the display, 22 denotes the element pixel group, 17a indicates the opening of the light shutter array panel, 17b denotes the light-blocking portion, 15 represents the light field rays, 16 signifies the light field ray group, and 16a indicates the origin of the light field ray group.

For example, by assigning a display panel's element pixel group of 3 pixels×3 pixels to one aperture 17a, as shown in FIG. 4, Here, it is possible to form nine Light-Field (LF 15) rays 16 with different polar angles (θ) or azimuth angles (φ). The number of LF ray origins (starting points) 16a (hereinafter referred to as LF ray origin number n_{P}) is 1/9 of the original display's resolution (number of pixels). In general, by assigning a display of N pixels×N pixels to one aperture, it is possible to form N\hat{ }2 LF rays with different polar angles (θ) or azimuth angles (φ) and the number of the LF ray origins 16a becomes 1/N\hat{ }2.

Here, the characteristic of the multi-layer method is the ability to vary the absolute angle α, radiation angle width β, light beam divergence angle γ, and origins of the light rays.

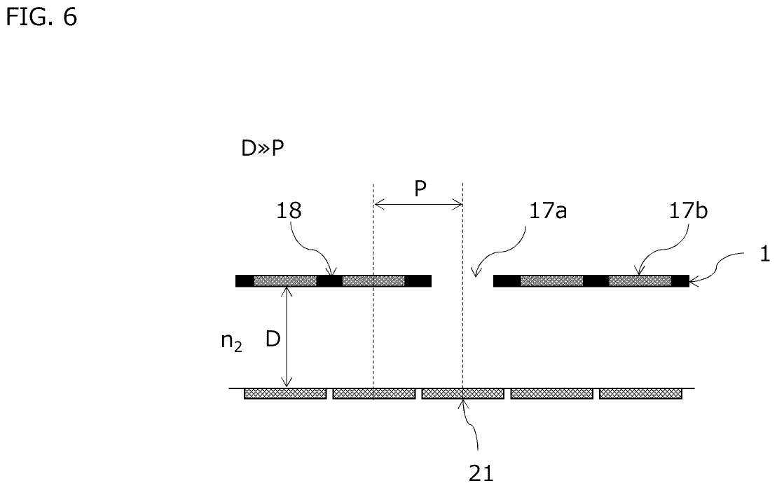

FIG. 6 shows the relationship between the pixels 21 of the display panel 2 and the aperture of the light shutter panel 1 (open state 17a, closed state 17b, boundary shading part 18). Here, P and D show a pixel pitch and a distance between the display panel and the light shutter array panel. n2 represents the refractive index between the display panel and the light shutter array panel. In this embodiment, due to the hollow structure, n2 is equal to 1.

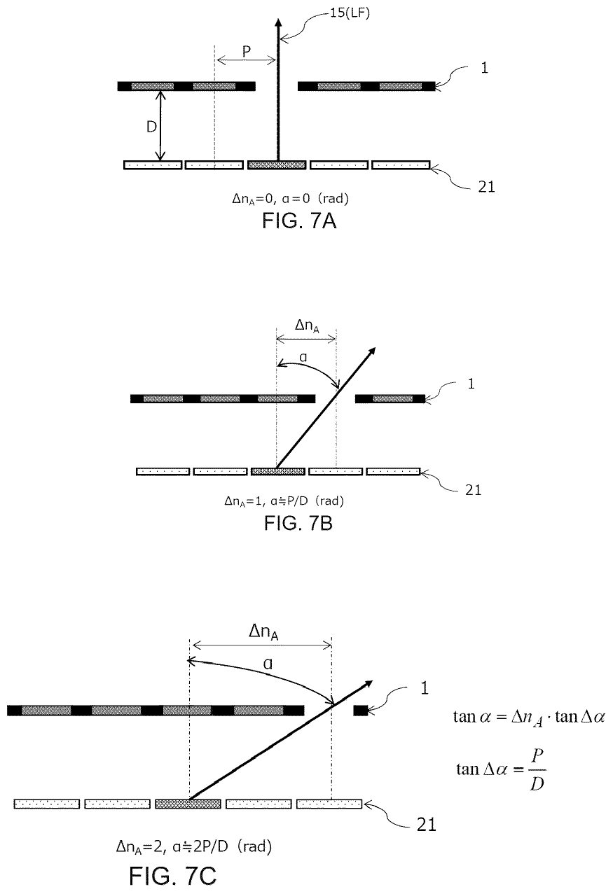

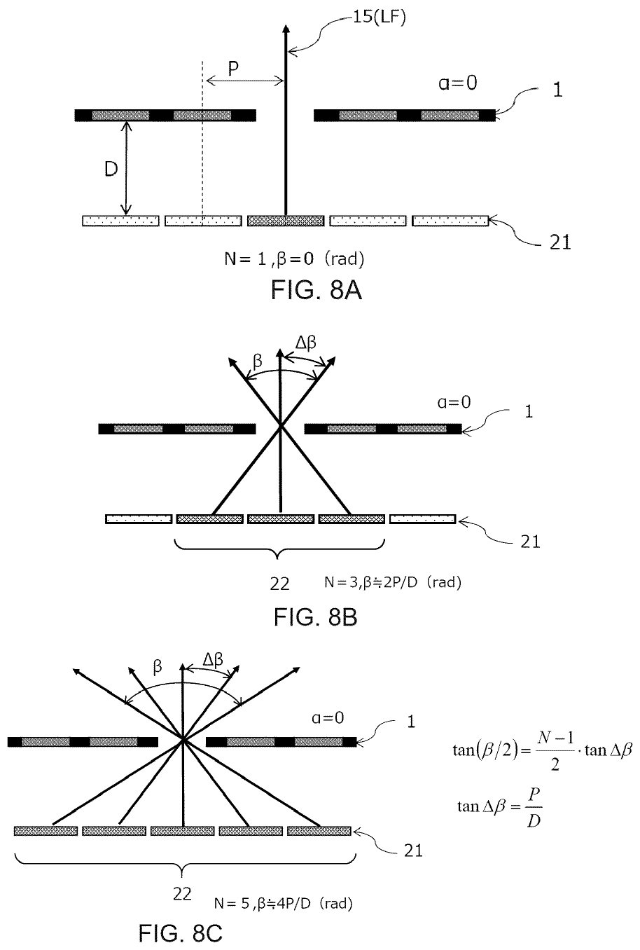

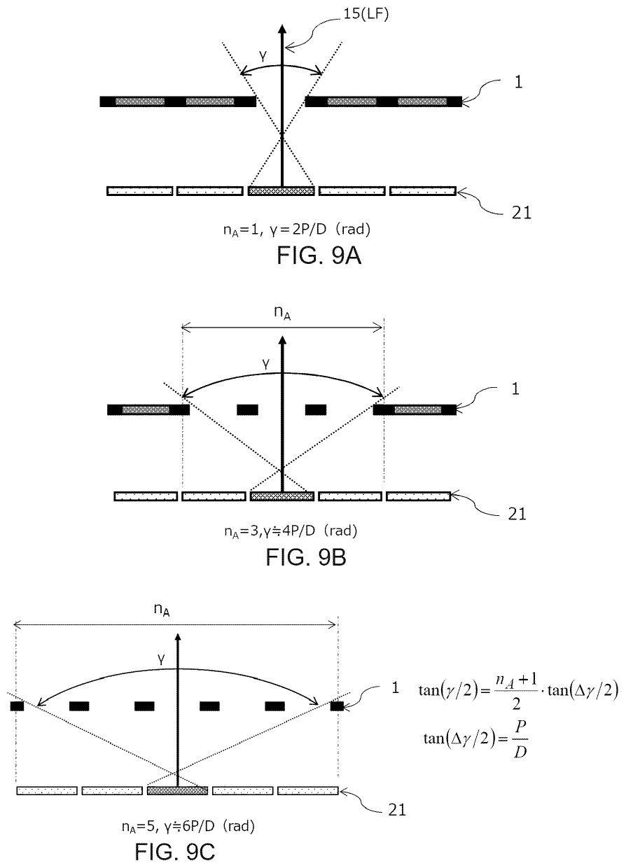

FIGS. 7A, 7B and 7C illustrate the method of controlling the absolute angle a of the LF rays, FIGS. 8A, 8B and 8C illustrate the method of controlling the radiation angle width β of the LF rays, and FIGS. 9A, 9B and 9C illustrate the method of controlling the light beam divergence angle γ, all represented in one dimension.

The absolute angle α of the LF is varied by changing the relative position of the aperture 17a with respect to the display pixels (hereinafter referred to as element pixels) 21 that form the basis of the LF rays. The radiation angle width β is varied by increasing or decreasing the number of element pixels 21 for one aperture 17a, i.e., the number of pixels in the element pixel group 22. To obtain a wider radiation angle width β, the number of pixels in the element pixel group 22 is increased, while to obtain a narrower radiation angle width β, the number of pixels in the element pixel group is decreased. Additionally, the light beam divergence angle γ is varied by increasing or decreasing the area n_{A} of the aperture 17a per element pixel 21, i.e., by adjusting the number n_{A} of pixels in the aperture. The origin of the LF rays is varied by changing the absolute position of the aperture corresponding to the absolute position of the element pixel group 22.

Among these parameters, the most important for resolving VAC is the radiation angle width β and its angular resolution Δβ, which are as follows:

$$tan ( β / 2 ) = \frac{N - 1}{2} \cdot tan Δβ \qquad ( 6 )$$

$$tan Δβ = \frac{P}{D} \qquad ( 7 )$$

D: Distance between the display panel and the light shutter panel
P: Pixel pitch of the display panel

Here, in the multi-layer method, high resolution can be achieved by switching the LF ray origins in a time-division driving manner.

For example, as shown in FIG. 5, a fixed period is divided into nine frames. During each of these nine divided frames, the openings are shifted by one pixel at a time, and simultaneously, the element pixel groups, which consist of nine pixels, are shifted in the same manner by one pixel. The images of the element pixel groups are switched accordingly. This process results in obtaining nine origins of light field rays (LF rays) for each pixel of the original display panel. In other words, to achieve an LF ray group of N×N rays with the same LF ray origin density as the original display resolution, it is necessary to configure an element pixel group of N pixels×N pixels and perform N\hat{ }2 division time-segmented driving.

However, the challenge with the multi-layer method is that the number of time divisions is limited by the response speed of the display panel and the light shutter panel, as well as the processing speed of the graphics board.

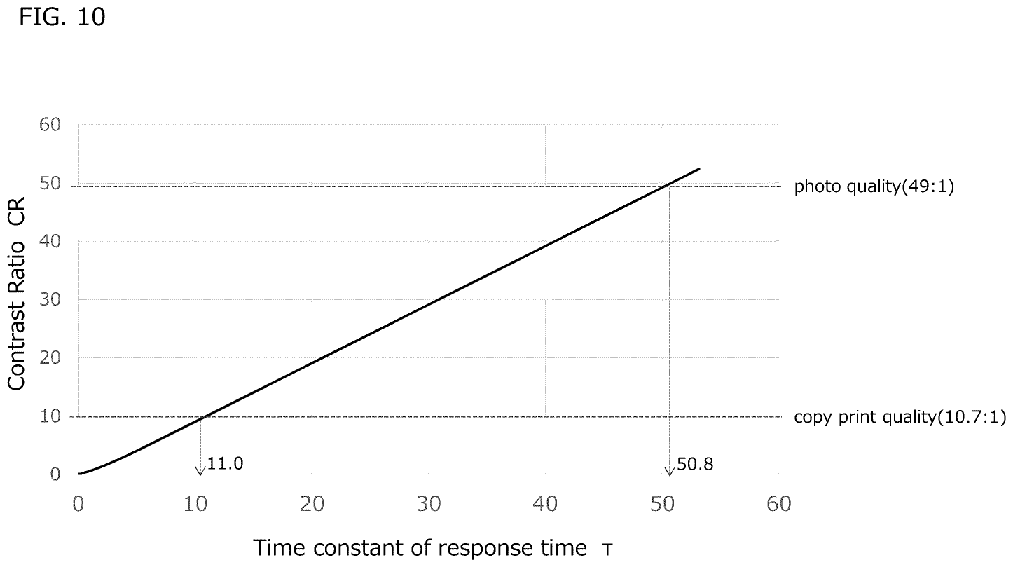

Specifically, FIG. 10. shows the relationship between the contrast ratio of the multi-layer method and the time constant of the panel's response characteristics. In the multi-layer method, in order to perform time-division driving, unlike conventional liquid crystal displays or lens array methods, all element pixels must be rewritten every frame. Therefore, extremely high switching performance is required for the element pixels.

As shown in FIG. 10, a contrast ratio of 10.7:1 or higher is required to achieve at least a copy print quality level, and a contrast ratio of 49:1 or higher is required to achieve a photo quality level. However, considering the slower response time of the display panel and light shutter panel in this embodiment, TOFF (3τ)=1.5 ms, the required frame rate (more accurately, the refresh rate of the panel) is limited. The maximum frame rate is then calculated to be 185 Hz or less, preferably 41 Hz or less.

In this embodiment, the fastest commercially available graphics board, the NVIDIA GeForce RTX 4090, is used. The rendering performance of this graphics board is approximately 180 fps for 4K (3840×2160 pixels) resolution. When processing 4 panels with 1440×1440 pixels same as 4K resolution in this embodiment, the maximum frame rate is limited to 180 fps.

For these two reasons, the maximum frame rate in this embodiment is determined to be 180 fps.

On the other hand, the response time of the crystalline lens, a major element in VAC focus adjustment, is generally in the range of 0.2 s to 2 s. Therefore, to resolve VAC, all LF outputs need to be updated within a response time of 0.2 s. This means that the frame rate of LF 3D images (hereinafter referred to as LF3D) can be reduced to 1/0.2=5 fps.

Here, regarding videos, it is generally recognized as a moving image if it is above 12 Hz. Therefore, it is sufficient to set the resolution of the LF ray's radiation angle, Δβ, so that at least three LF rays at 5 Hz enter the user's eye, especially within the discrimination visual field angle (within 5° of the field of view), and preferably within the fovea (within 1.5° of the field of view). In other words, the radiation angle resolution, Δβ, should be below 2.8°, and more desirably below 0.8°. In the present invention, for the purpose of eliminating VAC, the radiation angle resolution, Δβ, is set to be below 0.3°, so that 277 LF rays enter the discrimination visual field and 25 LF rays enter the fovea five times per second, which is equivalent to a 125 Hz moving image.

Therefore, frame rates such as 24 fps commonly used in movies, or 60 fps used to display fast-moving subjects like sports smoothly, are not a problem at all. However, the use of frame rates higher than 144 fps, which are required for shooting games and the like, remains a challenge. Furthermore, even if the frame rate of LF output is set to a low frequency, there will be no perception of flicker because it effectively becomes equivalent to 125 Hz or more. Generally, flicker is felt with brightness fluctuations below 50 Hz. From the above, the maximum number of time divisions in this embodiment is limited to 36, which is 180 divided by 5. That is, the maximum for N×N is 6×6.

Next, I will explain the field of view (FOV), crosstalk avoidance condition, brightness, and 3D resolution concerning the LF angular resolution Δβ, with the time division number N×N=6×6 as the upper limit.

Firstly, in LF displays, the relationship between the FOV, the number of rays N, and the LF angular resolution Δβ is as shown in Equation 3. Since the maximum value for the time division number in this embodiment is N=6, to satisfy Δβ<0.3, the FOV must be extremely narrow at 1.3°, which is impractical.

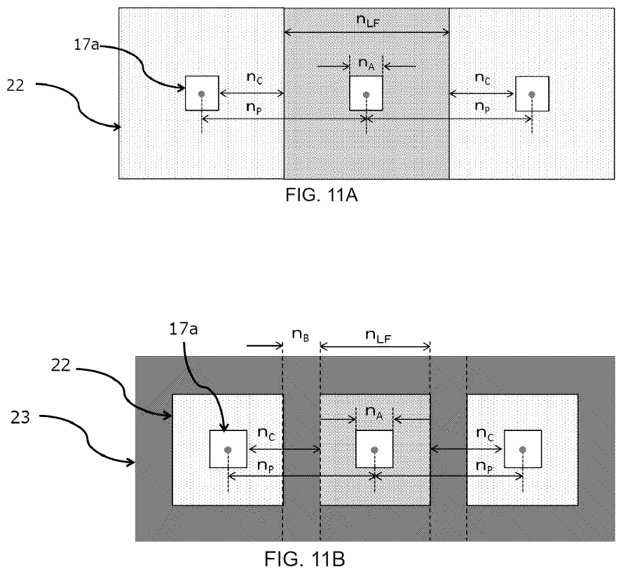

On the other hand, to eliminate crosstalk, the angle of occurrence of crosstalk must be increased to ensure it does not enter the peripheral visual field of the retina, where objects' shapes, contours, colors, and movements are recognizable (hereinafter referred to as crosstalk discrimination peripheral vision). Therefore, as shown in FIGS. 11A and 11B, a certain distance (in terms of pixels) n_{C} must be maintained between the boundary of the aperture and the boundary of the adjacent element pixel group. This distance n_{C} is referred to as the crosstalk avoidance distance. To achieve this, the area (in terms of pixels) n_{LF} of the element pixel group must be sufficiently large, and at the same time, the aperture area n_{A} of the light shutter must be sufficiently small. In the case of the light shutter method, since the upper limit of the number of element pixels is determined by the upper limit of the time division number, it is necessary to reduce the aperture area n_{A} significantly, leading to a significant decrease in brightness, which poses a serious challenge.

To improve the FOV and brightness, increasing Δβ or pixel size may be considered. However, increasing Δβ goes against the purpose of the present invention, which aims to satisfy Δβ≤0.3, and increasing pixel size reduces the number of LF rays and coarsens the pitch n_{P} of the LF ray origins, leading to a significant decrease in 3D resolution, which again goes against the purpose of the present invention.

In this embodiment, to address these challenges of conventional light shutter methods while satisfying Δβ<0.3, firstly, non-emissive padding pixels 23 without LF image information are placed around the LF element pixel groups 22. FIG. 11 illustrates this schematically. As shown in FIG. 11B, by placing padding pixels 23, it becomes possible to overlap the crosstalk avoidance region n_{C} with adjacent element pixel groups, unlike in the case without padding pixels as shown in FIG. 11A in conventional light shutter methods. This reduces the pitch n_{P} of the LF ray origins, leading to improved 3D resolution as described later, and at the same time, allows for an increase in the aperture area n_{A} of the light shutter, resulting in improved brightness.

That is to say, by appropriately setting the number of pixels ng in the padding region 23 and the aperture area 17a (number of pixels n_{A}) of the light shutter, it becomes possible to achieve both crosstalk elimination and 3D resolution under the condition of Δβ≤0.3, which was not achievable with conventional light shutter methods as shown in Comparative Examples 3 and 4. Additionally, it is possible to expand the aperture area n_{A} beyond the area of the effective element pixel group n_{LF} (referred to as LF effective pixel group) required to emit LF rays. In this embodiment, by setting the area of the LF effective element pixel group n_{LF} and the area of the aperture group n_{A} to be equal, brightness is significantly improved.

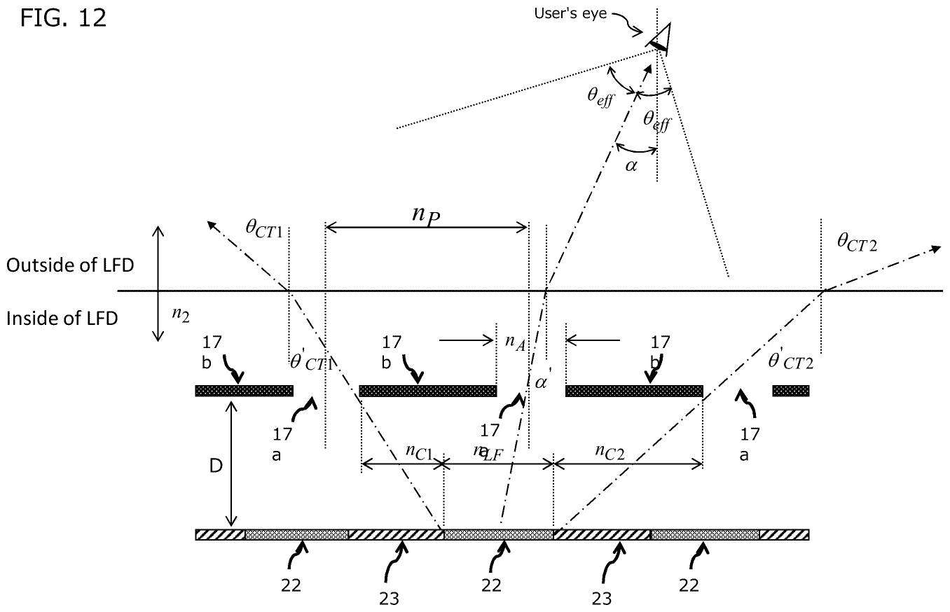

FIG. 12 illustrates the setting method for the padding region 23(n_{B}) and aperture area 17a(n_{A}) in this embodiment. The relationship between the number of pixels ng in the padding region, the number of pixels n_{A} in the aperture, and the total number of element pixels, i.e., the pitch (number of pixels n_{P}) of the LF ray origins, is expressed by the following equation.

$${n}_{C} = \frac{sin ( {θ}_{eff} + α )}{sin Δβ} \sqrt{\frac{1 - {sin}^{2} Δ β}{1 - {sin}^{2} ( {θ}_{eff} + α )}} ∝ \sqrt{\frac{1}{{sin}^{2} Δβ} - 1} \qquad ( 8 )$$

$${n}_{B} \geq {n}_{C} - \frac{1}{2} ( {n}_{LF} - {n}_{A} ) \qquad ( 9 )$$

$${n}_{P} \geq {n}_{C} + \frac{1}{2} ( {n}_{LF} + {n}_{A} ) = {n}_{B} + {n}_{LF} \qquad ( 10 )$$

Δβ: Radiation Angle Resolution
θ_{eff}: Maximum Angle of Peripheral Retina Capable of Recognizing Crosstalk
α: Absolute Angle of Gaze
n_{LF}: Number of Pixels in the Pixel Group Outputting the Light Field (Horizontal or Vertical)
n_{A}: Number of Pixels in the Aperture (Horizontal or Vertical)
n_{B}: Number of Pixels in the Padding Area (Horizontal or Vertical)
n_{C}: Number of Pixels Required to Eliminate Crosstalk (Horizontal or Vertical)
n_{P}: Total Number of Pixels Combining n_{LF} and n_{B} or Number of Pixels for the Pitch of the Light Field Ray's Origins (Horizontal or Vertical)
θ_{CT1}, θ_{CT2}, θ′_{CT1}, θ′_{CT2}: Crosstalk Occurrence Angle

As expressed in Equation 8, the smaller the value of Δβ, the greater the number of pixels n_{C} required to eliminate crosstalk. Additionally, to enhance brightness, it is also desired to increase the aperture area n_{A}. Therefore, to reduce the LF ray origin pitch n_{P}, it is effective to introduce padding pixels, as shown in Equation 10, to decrease n_{LF}.

Here, a comparison with the conventional light shutter method without the installation of padding pixels illustrated in FIG. 11A is explained.

In the conventional light shutter method, from Equations 9 and 10, we have:

$$N = {n}_{LF} = {n}_{P} \geq 2 {n}_{C} + {n}_{A} \qquad ( 11 )$$

Therefore, the difference in n_{P} due to the presence or absence of padding pixels in this embodiment is expressed by the following equation.

$$Δ {n}_{P} = {n}_{C} + \frac{1}{2} ( {n}_{A} - {n}_{LF} ) \qquad ( 12 )$$

From equation 12, it is evident that to maximize the effect of padding pixels, n_{A} should be increased and n_{LF} should be decreased. However, from equation 10, increasing n_{A} results in a larger absolute value of n_{P}, so it cannot be increased beyond necessity. Therefore, decreasing n_{LF} is the most effective approach.

Additionally, the brightness B is given by:

$$B ∝ {( \frac{{n}_{A}}{{n}_{P}} )}^{2} ( {n}_{LF} > {n}_{A} ) \qquad ( 13 )$$

$$or$$

$${( \frac{{n}_{LF}}{{n}_{P}} )}^{2} ( {n}_{LF} < {n}_{A} )$$

The value of B becomes maximum when n_{A}=n_{LF}.

Moreover, changing the area of the aperture n_{A} does not change the angle of the LF rays since it is determined by the angle between the center of the aperture and the center of each pixel in the element pixel group. Therefore, the number of LF rays N and their angular separation remain unchanged.

Furthermore, even if the area of the aperture n_{A} is changed, the radiation angle of the LF rays remains the same, as it is determined by the angle formed between the center of the aperture and the center of each pixel in the element pixel group.

Below, I'll explain the specific effects while comparing with the LF display (Comparison Example 1) using the lens array method and the LF display (Comparison Example 3) using the conventional optical shutter method.

In this embodiment, to satisfy a FOV (Field of View) of 44°, which is equivalent to Comparison Example 1, the number of pixels n_{LF} in the LF effective radiation pixel group is set to 156 pixels (H: Horizontal direction)×156 pixels (V: Vertical direction).

Additionally, to ensure Δβ≤0.3 and completely eliminate crosstalk under the crosstalk recognition condition (θeff+α≤40°), padding pixels n_{B} are set to 162 pixels based on equations 7 through 9, with 81 pixels placed around the LF effective pixel group. The total number of pixels in the entire pixel group (hereinafter referred to as the total pixel group) n_{P} is set to 318 pixels (H)×318 pixels (V). Furthermore, to maximize brightness, the number of pixels n_{A} in the aperture area (pixel group) is set to be the same as the LF effective pixel group n_{LF}, which is 156 pixels (H)×156 pixels (V).

The reason for setting the maximum value of θ_{eff}+α to 40° is based on experimental evaluations, taking into account the maximum angle where crosstalk generation is not tolerable, within the range of the maximum effective field of view of ±15°, where only eye movement is instantly acceptable, and the maximum range of stable gaze that can be comfortably observed, including head movement, of ±45°.

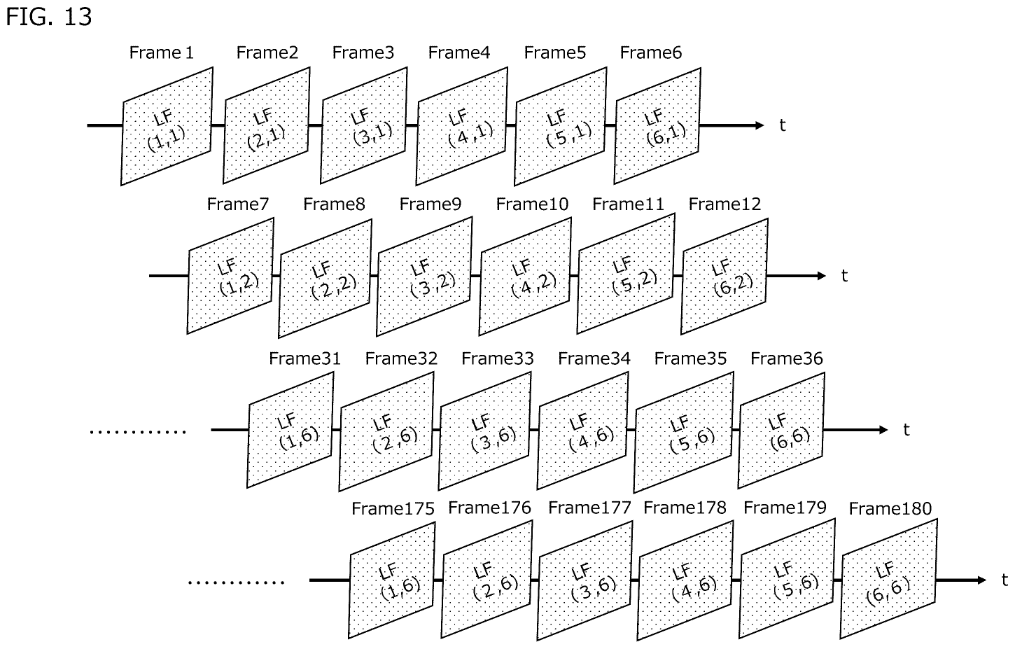

Next, with a time-division number N×N=6×6 (36 divisions), LF 3D images were projected five times per second at a frame rate of 180 fps. In each of the 36 frames divided by time, the position of the aperture and the LF effective pixel group was shifted horizontally and vertically by 53 pixels each. FIG. 13 shows the allocation of time divisions for each frame in this embodiment. Here, LF (1,1) indicates that an LF image of N×N=1×1 is being output.

As a result, the number of origins of LF rays emitted from the virtual image display surface 12 increased to 24 (H)×24 (V), surpassing Comparison Example 1. Additionally, the number of LF rays emitted from a single origin became 156 (H)×156 (V), resulting in a total LF ray count of 37,440 (H)×37,440 (V), seven times that of Comparison Example 1.

Moreover, unlike Comparison Examples 3 and 4, crosstalk became completely imperceptible. With the elimination of crosstalk, the contrast ratio also improved, achieving the target contrast ratio of 10.9 (copy quality level) compared to the conventional optical shutter method (Comparison Example 3). However, the contrast ratio in this embodiment is limited by the response speed of the liquid crystal cell used in the display panels and optical shutter, thus further improvement of response speed would be required.

Additionally, the brightness, which is another major drawback of the light shutter method, has been significantly improved, achieving an 8.6-fold increase compared to the conventional light shutter method's Comparative Example 3. However, compared to the lens array method (Comparison Example 1), only 48% brightness was achieved.

Moreover, the most critical factor determining 3D display quality, 3D resolution, also improved significantly while meeting Δβ≤0.3 to resolve the VAC. Specifically, the LF ray pitch n_{P} was reduced to 39.1 mm from 55.3 mm in the lens array comparison Example 1. Consequently, the 3D resolution increased from 227 points/m³ to 640 points/m³, a 2.8-fold improvement.

Furthermore, compared to Comparison Example 2, which achieved Δβ≤0.3 using an ultra-high-definition panel, this embodiment with a quarter of the resolution achieved a 2.4-fold increase in 3D resolution.

Here, in this invention, the density of LF ray intersection points per unit volume in the 3D cognition space is defined as the 3D resolution R_{3D} (/m³), serving as an indicator of the precision of 3D display. Specifically,.

$${R}_{3 D} = \frac{tan {β}_{min}}{{( {n}_{P} \cdot P )}^{3}} \qquad ( 14 )$$

P: Pixel Pitch
βₘᵢₙ: The Minimum Light Field Radiation Angle Required to Eliminate VAC) (1.1°)

In this embodiment, by providing padding pixels around the LF element pixel group, it was possible to resolve the VAC and achieve an LF angular resolution Δβ≤0.3 in the optical shutter method, This allowed for the simultaneous elimination of crosstalk and increased brightness, overcoming the drawbacks of the optical shutter method. Moreover, it enabled a significant improvement in 3D resolution by reducing the LF ray pitch.

Furthermore, unlike the lens array method, achieving these benefits did not require the use of costly ultra-high-definition panels. Consequently, particularly for 3D images within 1 meter, discomfort from VAC was eliminated, providing high-fidelity images suitable for detailed tasks for extended periods, all at an affordable price for an HMD.

The applications extend to various fields including healthcare, design, prototyping, education, training, sales, and retail (advertising, digital commerce), wherever high-fidelity 3D images with high resolution and prolonged use are desired, without specific limitations.

Additionally, the LF radiation angle width β may be adjusted based on user settings, considering factors such as presbyopia, myopia, and hyperopia, allowing for clear 3D image observation without glasses when using the HMD.

Moreover, in this embodiment, the invention has been applied to an HMD, but the LFD of the present invention is not limited to HMDs. For example, it can also be used as a display device such as a direct-view flat panel display, a digital microscope, and same effects can be obtained.

Regarding alignment during the bonding of the optical shutter panel 1 and the display panel 2, while precise alignment during the manufacturing process is essential, digital correction using software after product completion is also feasible. In the case of the optical shutter method, where the position of the aperture can be adjusted to some extent at the expense of some pixels, digital correction of alignment is a characteristic feature.

### Comparative Example 1

This comparative example simulates an HMD using a lens array type LFD (NHK, announced on May 19, 2022, reference: NHK Announcement).

In this configuration, the lens array is placed in front of the display panel instead of the light shutter panel used in Embodiment 1. The lens array consists of microlenses with a focal length of 15.0 mm arranged in a 17 (H)×17 (V) grid with a pitch of 3.0 mm. Thus, the number of element pixels is set to 83 (H)×83 (V), which is the maximum odd number when the display's pixel count of 1440 is divided by the number of lenses in the array (17).

For rendering processing, an NVIDIA GeForce RTX 4070 was used, with a driving frequency (frame rate) of 60 Hz (fps).

Here, to achieve a field of view (FOV) of 44° both vertically and horizontally, as per the published data, the LF emission angle resolution Δβ is 0.6° based on Equation 1. The distance between the display panel and the lens array is 3.7 mm.

Other than the differences mentioned above, this configuration is the same as in the first embodiment.

Therefore, in this comparative example, the LF emission angle resolution Δβ does not meet the requirement of being 0.3 or less, and the VAC is not resolved.

Regarding 3D display performance, the number of LF light ray origins is 17 (H)×17 (V), with each origin emitting 83 (H)×83 (V) LF light rays, resulting in a total of 1411 (H)×1411 (V) LF light rays.

Notably, in the lens array method, unlike the light shutter method, the microlenses' light-gathering effect, with appropriately set focal lengths, makes it less likely to receive light rays emitted from the boundaries of adjacent element pixel groups, thereby reducing crosstalk. Additionally, since the light rays emitted from a single element pixel can be focused and emitted, there is minimal loss in brightness.

On the other hand, since the lens array is fixed, the number of origins for the LF light rays is the same as the number of lenses in the array and cannot be increased through time-division driving. As a result, the origin pitch becomes extremely coarse, and the 3D resolution is also low. In this comparative example, the origin pitch is 55.3 mm, and the 3D resolution R3D is 227 points/m³.

As described above, this comparative example does not achieve an LF emission angle resolution Δβ of 0.3 or less and has extremely low 3D resolution R3D. Additionally, the FOV is narrow, and it does not reach a practical level for use as an HMD.

### Comparative Example 2

In this comparative example, the display panel from Comparative Example 1 was replaced with a high-definition panel with a pixel count of 2880 (H)×2880 (V). The pixel pitch was halved to 0.018 mm both horizontally and vertically. The lens array was also changed to a high-density configuration with 18 (H)×18 (V) lenses and a pitch of 2.9 mm. The number of element pixels was set to 155 (H)×155 (V).

With the high-definition panel having approximately four times the number of pixels, the LF emission angle resolution Δβ was improved to 0.3 while maintaining the same field of view (FOV) of 44° as in Comparative Example 1. The distance between the display panel and the lens array was 3.5 mm.

Other than these differences, this configuration is the same as in Comparative Example 1.

In terms of 3D display performance, the number of LF light ray origins is 18 (H)×18 (V), with each origin emitting 155 (H)×155 (V) LF light rays, resulting in a total of 2790 (H)×2790 (V) LF light rays, approximately four times that of Comparative Example 1.

In this comparative example, the origin pitch was slightly reduced to 52.2 mm, and the 3D resolution R3D slightly improved to 270 points/m³. However, it remains low, and the image is coarse.

As described above, although this comparative example achieved an LF emission angle resolution Δβ of 0.3 or less by using a high-definition panel, the 3D resolution R3D remains extremely low, similar to Comparative Example 1. Additionally, the FOV is narrow, and it does not reach a practical level for use as an HMD.

Furthermore, due to the increased rendering load, which is eight times higher than in Comparative Example 1, the upper limit of processing with the NVIDIA GeForce RTX 4070 is 69.1 fps.

### Comparative Example 3

This comparative example demonstrates the use of a conventional light shutter method. Except for the differences noted below, it is identical to Embodiment 1.

In this example, the number of element pixels was determined by the time-division number, set to 6 (H)×6 (V). The light shutter panel's opening was set to 1 pixel×1 pixel.

To achieve an FOV of 44° as in Embodiment 1, the LF emission angle resolution Δβ is 9.2. The distance between the display panel and the light shutter panel is 0.2 mm.

Therefore, in this comparative example, the LF emission angle resolution Δβ does not meet the requirement of being 0.3 or less, and the VAC is not resolved.

In terms of 3D display performance, considering the N-fold increase by time-division driving, the number of LF light ray origins is the same as the number of display pixels, 1440 (H) x1440 (V). The number of LF light rays emitted from each origin is 6 (H)×6 (V), resulting in a total of 8640 (H)×8640 (V) LF light rays.

As a result, the origin pitch is extremely small at 0.65 mm, and the 3D resolution R3D is extremely high at 1.38×10\hat{ }8 points/m³.

However, in the light shutter method, light rays emitted from the boundaries of adjacent element pixel groups can enter the opening, making crosstalk likely. Additionally, much of the light emitted from the element pixels is blocked by the light shutter, resulting in extreme dimness.

Therefore, despite increasing the LF emission angle resolution Δβ to 9.2° in this comparative example, crosstalk is observed throughout the display space, even when viewed from the front, reducing the contrast ratio from 10.9 in Embodiment 1 to 8.4. Furthermore, the coarse LF emission angle resolution Δβ results in non-smooth changes in the 3D image when the viewing angle is changed, appearing as a double image, severely degrading 3D display quality.

Although increasing the time-division number can improve crosstalk, the response speed of the display panel and light shutter panel, as well as the upper limit processing capacity of the graphics board, prevent further increases in the time-division number in this comparative example, as in Embodiment 1.

Moreover, the brightness is only 5.6% of the lens array method (Comparative Example 1), making the display image extremely dim.

### Comparative Example 4

This comparative example is identical to Comparative Example 3 except for the following:

The distance between the display panel and the light shutter panel was set to 6.8 mm, achieving an LF emission angle resolution Δβ of 0.3.

As a result, the brightness was even lower than in Comparative Example 3, and the crosstalk was so severe that the image pattern was completely unrecognizable. Additionally, the FOV was less than 1°.

Therefore, the conventional light shutter method cannot satisfy an LF emission angle resolution Δβ of 0.3° or less.

As described above, although the conventional light shutter method can significantly increase the number of LF light rays and the 3D resolution R3D, it cannot achieve an LF emission angle resolution Δβ of 0.3 or less. The 3D quality is extremely poor, the brightness is extremely low, and the FOV is narrow. Therefore, it does not reach a practical level for use as an HMD compared to the lens array method.

### Embodiment 2

This embodiment is identical to Embodiment 1, except for the following additions:

In this embodiment, a gaze tracking function, commonly known as an eye-tracking sensor, is added to track the user's gaze. The absolute angle of the gaze (α) is used to control the relative position between the opening of the light shutter and the entire element pixel group of the display.

Specifically, based on the absolute angles of the gaze (α, φ), the relative position of the center coordinates (xP, yP) of the entire element pixel group of the display panel to the center coordinates (xA, yA) of the opening of the light shutter panel is controlled as follows:

$${x}_{P} = {x}_{A} + Δ {x}_{PA} = {x}_{A} + D tan α cos ϕ \qquad ( 15 )$$

$${x}_{P} = {y}_{A} + Δ {y}_{PA} = {y}_{A} + D tan α sin ϕ \qquad ( 16 )$$

At this time, Equations 8, 9, and 10 are transformed as follows. Here, for simplicity, the case where φ=0°, i.e., considering the horizontal direction, is shown below:

$${n}_{C 1} = \frac{sin ( {θ}_{eff} + α )}{sin Δβ} \sqrt{\frac{1 - {sin}^{2} Δ β}{1 - {sin}^{2} ( {θ}_{eff} + α )}} \qquad ( 17 )$$

$${n}_{C 2} = \pm \frac{sin ( {θ}_{eff} - α )}{sin Δβ} \sqrt{\frac{1 - {sin}^{2} Δ β}{1 - {sin}^{2} ( {θ}_{eff} - α )}} \qquad ( 18 )$$

$${n}_{B} = \frac{1}{2} ( {n}_{C 1} + {n}_{C 2} + {n}_{A} - {n}_{LF} ) \qquad ( 19 )$$

$${n}_{p} = \frac{1}{2} ( {n}_{C 1} + {n}_{C 2} + {n}_{A} + {n}_{LF} ) = {n}_{B} + {n}_{LF} \qquad ( 20 )$$

n_{C1}: Number of Pixels Required on One Side to Eliminate Crosstalk (Horizontal or Vertical)
n_{C2}: Number of Pixels Required on the Other Side to Eliminate Crosstalk (Horizontal or Vertical)

That is, in the case without control by gaze tracking, twice the number of pixels n_{C1} shown in Equation 17 is required for the crosstalk avoidance area. As the absolute angle α increases, the number of pixels n_{C1} also increases. However, when the display position of the element pixel group is controlled by gaze tracking, the number of pixels n_{C2} shown in Equation 18 decreases with the absolute angle α, allowing the number of padding area pixels n_{B} to be reduced. As a result, the size of the entire element pixel group is also reduced, which decreases the LF light ray origin pitch n_{P}, thus improving the 3D resolution. Additionally, since the ratio of n_{LF} to n_{P} can be increased, the brightness can also be greatly improved as shown in Equation 13.

Specifically, while the effective LF pixel group n_{LF} remains at 155 pixels (H)×155 pixels (V), the entire element pixel group n_{P} can be reduced from 317 pixels (H)×317 pixels (V) in Embodiment 1 to 271 pixels (H)×271 pixels (V).

As a result, the number of LF light ray origins n_{P} increased from 24 (H)×24 (V) in Embodiment 1 to 30 (H)×30 (V), and the total number of LF light rays improved to 4650 (H)×4650 (V).

Furthermore, the brightness improved by 1.4 times compared to Embodiment 1, achieving 65% of the brightness of Comparative Example 1.

Moreover, the 3D resolution was also significantly improved, with the LF light ray origin pitch n_{P} reduced from 39.1 mm in Embodiment 1 to 31.3 mm, and the 3D resolution increased from 640 points/m² to 1250 points/m², achieving 5.5 times that of Comparative Example 1.

Thus, in this embodiment, by adding a gaze tracking function and controlling the relative positional relationship between the center coordinates of the opening and the center coordinates of the entire element pixel group based on the gaze angle data, it was possible to further improve the 3D resolution and brightness compared to Embodiment 1, in addition to the effects of Embodiment 1.

### Embodiment 3

This embodiment is identical to Embodiment 2, except for the following additions:

In this embodiment, the space between the display panel and the light shutter panel is characterized by having a high refractive index n₂. Specifically, an acrylic plate with a refractive index of approximately n₂≈1.5 is inserted between the display panel and the light shutter panel, and bonded together with a high refractive resin.

As a result, the angle of the LF light rays output from the LFD is widened compared to the angle inside the LFD itself, thereby further reducing both the LF effective pixel group n_{LF} and the padding area pixel number n_{B}. Additionally, by adjusting the area of the opening n_{A} to be divisible by the total pixel number of the panel within the entire element pixel group n_{P}, the LF light ray origin pitch n_{P} can be further reduced, thereby improving the 3D resolution.

The reduction effect of the entire element pixel group n_{P} due to the high refractive index between the display panel and the light shutter panel can be derived from the following equation and Equation 20:

$${n}_{C 1} = \frac{sin ( {θ}_{eff} + α )}{sin Δβ} \sqrt{\frac{1 - {( \frac{1}{{n}_{2}} )}^{2} {sin}^{2} Δβ}{1 - {( \frac{1}{{n}_{2}} )}^{2} {sin}^{2} ( {θ}_{eff} + α )}} \qquad ( 21 )$$

$${n}_{C 2} = \pm \frac{sin ( {θ}_{eff} - α )}{sin Δβ} \sqrt{\frac{1 - {( \frac{1}{{n}_{2}} )}^{2} {sin}^{2} Δβ}{1 - {( \frac{1}{{n}_{2}} )}^{2} {sin}^{2} ( {θ}_{eff} - α )}} \qquad ( 22 )$$

That is, the higher the refractive index between the display panel and the light shutter panel, the fewer the padding area pixels required.

Specifically, the LF effective pixel group n_{LF} was set to 152 pixels (H)×152 pixels (V), the entire element pixel group n_{P} to 240 pixels (H)×240 pixels (V), and the opening pixel number n_{A} to 122 pixels (H)×122 pixels (V).

As a result, the number of LF light ray origins n_{P} increased to 36 (H)×36 (V), and the total number of LF light rays improved to 5472 (H)×5472 (V).

Furthermore, the LF light ray origin pitch n_{P} could be reduced to 21.6 mm, and the 3D resolution improved to 2161 points/m², which is 1.7 times that of Embodiment 2 and 9.5 times that of Comparative Example 1.

On the other hand, brightness decreased slightly due to the reduction of the opening area n_{A}, to 79% of Embodiment 2 and 52% of Comparative Example 1. However, if the opening area is kept the same, setting the LF effective pixel group n_{LF} and the opening pixel number n_{A} to the same value would improve brightness by 1.1 times compared to Embodiment 2, achieving 72% of the brightness of Comparative Example 1.

Therefore, the effect of this embodiment is that by setting the total pixel number of the display panel to be divisible by the optimal total element pixel group number, both the improvement in 3D resolution and brightness can be simultaneously achieved.

In summary, this embodiment, by incorporating a high refractive index between the display panel and the light shutter panel, not only achieves the effects of Embodiment 2 but also further improves 3D resolution and brightness. Additionally, by fixing the display panel and the light shutter panel with an acrylic plate and transparent resin, mechanical vibration and shock resistance of the LFD can be enhanced.

Note that while this embodiment uses an acrylic plate, any high refractive index material can be used, such as glass, and is not specifically limited to acrylic. However, from the perspective of weight, it is desirable to choose a material with a lower specific gravity.

### Embodiment 4

This embodiment is identical to the embodiment 3 except for the following differences:

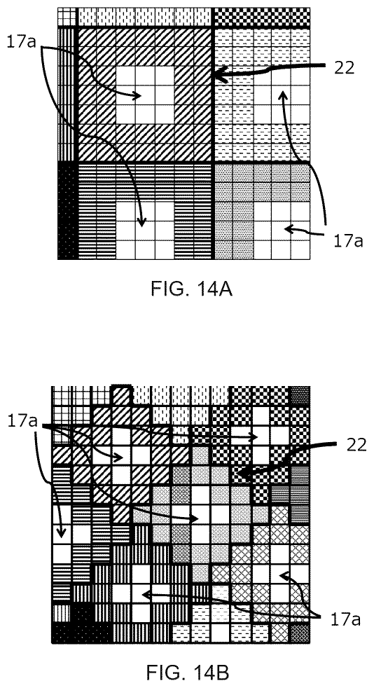

FIGS. 14A and 14B illustrate the square-shaped element pixel groups of Embodiment 1 to 3 and the diamond-shaped element pixel groups of this embodiment, along with examples of the arrangement of some of the pixel groups within the image area. Note that for clarity, FIGS. 14A and 14B show an example where the LF effective pixel group n_{LF} consists of 7 horizontal pixels×7 vertical pixels. However, the number of pixels can be set arbitrarily and is not limited to this example.

In this embodiment, the shape of the element pixel groups is changed to a diamond shape as shown in FIG. 14B. This change reduces the area (number of pixels) of the entire element pixel group to half of the square shape shown in FIG. 14A, and the LF light ray origin pitch n_{P} can be reduced to 1/√2. As a result, the 3D resolution can be further improved.

Specifically, the LF effective pixel group n_{LF} is shaped as a diamond with 152 pixels (H)×152 pixels (V), the entire element pixel group n_{P} as a diamond with 240 pixels (H)×240 pixels (V), and the opening pixel number n_{A} as a diamond with 148 pixels (H)×148 pixels (V).

As a result, the number of LF light ray origins increased to the equivalent of 48 (H)×48 (V). Consequently, the LF light ray origin pitch n_{P} could be reduced to 19.5 mm, and the 3D resolution improved to 5216 points/m², which is 2.4 times that of Embodiment 3 and 23 times that of Comparative Example 1.

Here, the term “equivalent” is used because (H) and (V) are not strictly horizontal and vertical directions. However, the values after multiplication remain the same, making this expression easier to understand when comparing with other examples.

On the other hand, the total number of LF light rays slightly decreased to 5159 (H)×5159 (V) compared to Embodiment 3 due to the halving of the LF effective pixel number, offsetting the effect of the reduced LF light ray origin pitch. However, this is still more than 13 times that of Comparative Example 1, achieving a sufficient number of light rays.

Additionally, the brightness improved further, exceeding the highest level achieved in Embodiment 2 by 5.4%, reaching 69% of that in Comparative Example 1.

However, changing the element pixel group to a diamond shape has the side effect of reducing the field of view (FOV) to 1/√2 when the azimuth angles are 45°, 135°, 225°, and 315°.

In summary, this embodiment, by changing the element pixel groups to a diamond shape, not only achieves the effects of Embodiment 3 but also further improves both the 3D resolution and brightness.

Although this embodiment uses a diamond shape, other shapes such as circular, elliptical, or concentric polygons can also be used, as long as they reduce the area of the entire element pixel group. Asymmetric shapes in the horizontal and vertical directions are also acceptable. However, the diamond shape used in this embodiment provides the greatest reduction effect.

### Embodiment 5

This embodiment is identical to Embodiment 4 except for the following differences:

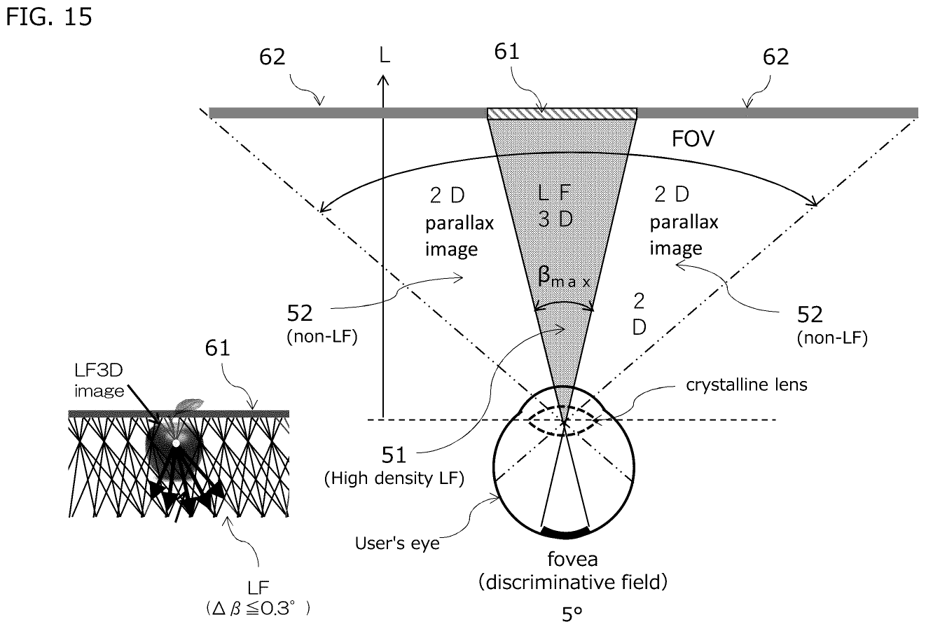

FIG. 15 shows a conceptual diagram of this embodiment. In this embodiment, the LF (Light Field) is output only within the central visual field 51, particularly the discriminative visual field, which operates based on the high information reception capability of the fovea. This minimizes the number of LF rays to the essential minimum. That is, the number of pixels in the LF effective element pixel group can be reduced to the essential minimum. On the other hand, the LF radiation angle resolution Δβ can be further decreased, allowing the formation of higher density LF rays.

To eliminate VAC (Vergence-Accommodation Conflict), it is necessary to output LF rays to the fovea; conversely, there is no need to output LF rays elsewhere. Thus, LF ray output is required only within the angle of the discriminative visual field, corresponding to the fovea and parafovea, and within the image display area visible within this angle.

Here, the discriminative visual field refers to the area perceived by the fovea (including the parafovea) where visual functions such as visual acuity and color discrimination are excellent, and information can be instantly received without eye movement. The visual angle is within approximately 5° (±2.5°). Focus adjustment related to VAC is performed by perceiving this discriminative visual field, particularly the fovea region, making it crucial to obtain high-density LF information in this region.

However, if this approach is taken, the display will not be visible beyond the central visual field 51, significantly reducing the field of view (FOV). Therefore, this embodiment focuses LF output within the central visual field 51 and provides a non-LF frame period that displays a parallax-based 2D image, allowing the peripheral visual field 52 beyond the central visual field to be visible.

In this embodiment, the LF radiation angle resolution Δβ can be made smaller, and the number of LF rays can be increased without compromising the overall FOV.

Furthermore, by not emitting LF rays from the peripheral region, the crosstalk caused by LF 3D in the peripheral field of view region is eliminated. As a result, θeff, as shown in Equations 21 and 22, becomes extremely small. Additionally, projecting 2D images onto the peripheral field of view makes the LF crosstalk almost unnoticeable in the peripheral field, which has a lower ability to distinguish crosstalk. Consequently, the padding area can be significantly reduced. Therefore, the LF ray origin density can be increased, further improving the 3D resolution.

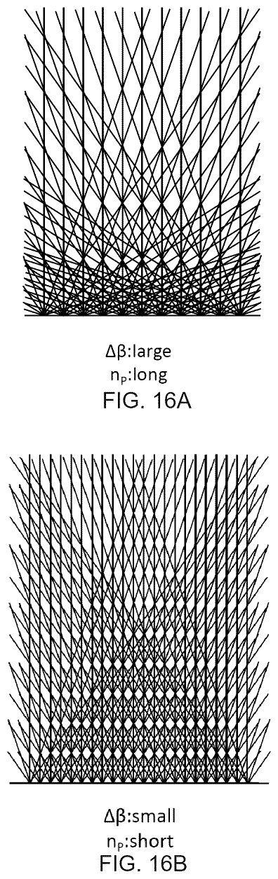

Furthermore, a drawback of LFD (Light Field Display) is that while the display quality of 3D images near the display surface is high, the density of LF rays decreases as the distance from the display surface increases, degrading the 3D image. However, by focusing LF rays within the central visual field angle 51 in this embodiment, it is possible to set a smaller LF radiation angle resolution Δβ for the same number of LF effective pixels, enabling the formation of a uniformly high-density 3D space across both close and distant viewing distances. FIGS. 16A and 16B show the changes in LF ray density (spatial frequency) concerning depth direction (viewing distance direction). When compared with the same number of LF rays N, as shown in FIG. 16A, increasing the LF angle resolution Δβ to widen the FOV results in a longer origin pitch n_{P} for the LF rays, making the FOV wide but allowing high-quality LF3D images to be recognized only near the display surface, narrowing the depth direction range. Conversely, as shown in FIG. 16B, decreasing the LF angle resolution Δβ shortens the origin pitch np, narrowing the FOV but expanding the range in the depth direction where LF 3D images can be recognized. Therefore, the primary goal of this invention is to improve the reproducibility and precision of 3D images at close viewing distances, thereby enhancing the realism of 3D images seen up close.

This method is named the Condensed Light-Field (CLF) method in this invention. Specifically, in this embodiment, the necessary maximum radiation angle of the LF rays, βmax is set to ±3.3°, considering the effects at a viewing distance of 30 cm in the discrimination visual field. Furthermore, in this embodiment, because a diamond-shaped element pixel group is used, to compensate for the decrease in field of view angle at azimuth angles of 45°, 135°, 225°, and 315°, the necessary maximum radiation angle βmax in the horizontal and vertical directions is set slightly beyond ±4.3° to ±5.

As a result, the number of required LF rays N×N, which previously needed to be output over the entire FOV, is significantly reduced, with the necessary number of LF rays N×N=30 (H)×30 (V) in this embodiment. Thus, the LF effective pixel group n_{LF} is set to a diamond shape of 30 pixels (H)×30 pixels (V). Additionally, the padding pixel number nB is also significantly reduced to 18 pixels, as the effective angle θeff in Equations 21 and 22 can be equal to βmax. Therefore, the entire element pixel group n_{P} is set to a diamond shape of 48 pixels (H)×48 pixels (V), and the opening pixel number n_{A} is set to a diamond shape of 30 pixels (H)×30 pixels (V) to match the LF effective pixel group n_{LF}.

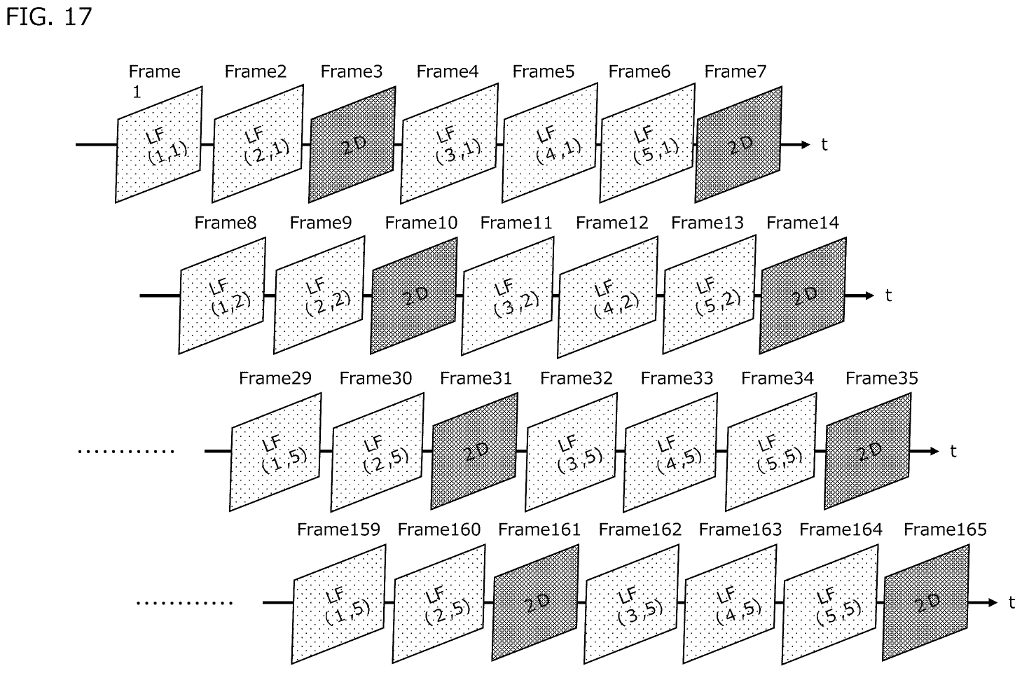

FIG. 17 shows the time-division allocation of each frame in this embodiment. In this embodiment, to provide a non-LF frame period that does not emit LF rays, the number of time divisions for LF is reduced to 25 (5×5). The overall frame rate is set to 175 fps, with 125 frames used for LF time-division drive and 50 frames for the 2D display frame period. Here, 2D in FIG. 17 indicates frames where 2D images are output.

In this embodiment, during the non-LF frame period, 2D images with parallax information for both eyes are displayed. This allows 2D parallax images to be viewed in the peripheral visual field 52 outside the central visual field 51, irrespective of the LF ray's FOV, thereby broadening the effective FOV.

In this Embodiment, during the LF frame period, all apertures of the light shutter panel in the peripheral field of view are closed. This is not only to prevent the LF 3D image from being displayed in the peripheral visual field but also to ensure that the display of the elemental pixel group projecting the LF 3D image within the central visual field does not leak through the apertures in the peripheral region. Therefore, the recognition of crosstalk can be further reduced.

Furthermore, during the non-LF frame period, to ensure that 2D displays are not recognized within the central visual field angle 51, a pattern is displayed that takes the logical OR of the inverted full-aperture pattern of the frames emitting LF rays, effectively closing the light shutter within the central visual field angle. This prevents the degradation of LF3D images due to the mixture of LF3D images and 2D parallax images, ensuring VAC elimination and maintaining LF3D display quality.

Here, regarding the number of 2D display frames, the more, the better to reduce flicker, but considering the trade-off with the number of LF rays and the upper limit of the overall frame frequency, this embodiment sets it to 50 frames. Ideally, there should be at least 45 frames. Additionally, it is desirable for the 2D display frames to be evenly distributed across the entire frame, as shown in FIG. 17. In this embodiment, the brightness of the LF3D image was matched with the brightness of the 2D display by setting the frame distribution accordingly.

As a result, in this embodiment, the number of LF ray origins is improved to an equivalent of 205 (H)×205 (V), and the LF ray origin pitch n_{P} can be reduced to 6.38 mm. The 3D resolution is significantly improved to 1.5×10⁵ points/m², 29 times that of Embodiment 4 and 672 times that of Comparative Example 1. Additionally, by setting the focal length of the eyepiece lens to 46 mm and changing the distance from the eyepiece lens to the LFD to 44.2 mm, the FOV could be expanded to 60°, regardless of the LF output conditions. This achieved a total LF ray number equivalent to 30,319 (H)×30,319 (V), 35 times that of Embodiment 4, 66 times that of Embodiment 1, and 462 times that of Comparative Example 1. Consequently, the 3D display quality in this embodiment significantly improved, providing a level of realism as if viewing a real object up close.

Furthermore, the brightness improved by 5.4% compared to the highest level achieved in Embodiment 2, reaching 69% of that in Comparative Example 1.

In summary, this embodiment achieves the effects of Embodiment 4 and improves 3D resolution and the total number of LF rays while maintaining the elimination of VAC and crosstalk by outputting LF only within the central visual field angle and providing a non-LF frame period to display 2D parallax images. Additionally, the FOV expansion is achieved.

In this embodiment, the LF rays are restricted to ±5° considering the discriminative visual field angle, but they can be expanded to the parafoveal visual field angle of ±10° or the effective visual field angle range of ±15°. However, in such cases, the number of pixels in the LF effective pixel group increases, reducing the density of LF ray origins, slightly decreasing the 3D resolution. On the other hand, the brightness in the central visual field improves, making LF3D images easier to see. When used as a glasses-free 3D display, the effective field of view βE needs to be set to approximately 20° to 30°, including a difference of about 10 to 15° in absolute angles between the central fields of view of both eyes.

Additionally, in this embodiment, gaze tracking control, as in Embodiment 2, is essential. However, it is not mandatory for Embodiment 3 and 4. In this example, the element pixel group was diamond-shaped, but the effects are the same even with a square shape.

As a result, in this embodiment, by forming LF according to the visual angle characteristics of the human eye and rendering method, practical increases in LF numbers, significant reductions in rendering load, good overall image formation, and substantial reductions in power consumption are achieved. Furthermore, more faithful 3D still images are obtained, smooth 3D videos are realized, and high-quality 3D spatial cognition in a wide field of view is achieved. This significantly improves the viewer's information reception capacity. As a result, motion parallax when looking into the distance and the appearance of moving objects while tracking with the eyes appear more natural.

### Embodiment 6

This embodiment is identical to Embodiment 5 except for the following.

In Embodiment 5, there was a tendency for the brightness of LF 3D images to be slightly darker than that of 2D images. Therefore, in this embodiment, the brightness control over time was performed by adjusting the brightness of the backlight during LF frame display and non-LF frame display (2D display) to match. This eliminates the difference in brightness between the central visual field and the peripheral visual field, allowing the entire space to be perceived as a natural 3D space.

Conversely, if users want to make LF3D images easier to see, the brightness during LF frame display can be increased, while reducing the brightness of the backlight during non-LF frame display (2D display) by the same amount, thus improving the brightness of the 3D images without increasing power consumption.

Furthermore, by performing brightness control of the backlight through local dimming, the brightness of the backlight can be increased in the central visual field during LF display frames while darkening the peripheral visual field. Conversely, during non-LF display (2D display) frames, the brightness of the central visual field can be decreased while increasing the brightness of the peripheral visual field. This further prevents LF3D images and 2D disparity images from mixing in the central and peripheral visual fields. Additionally, by significantly reducing the emitting area of the backlight during LF display frames, which have a low transmittance, the power consumption of the backlight can be greatly reduced. Specifically, in a setting with a field of view (FOV) of 60° and a discrimination visual field θ_{f} of 5°, the ratio of the discrimination visual field area SF to the entire display area S_{D} is given by Equation 23,

$$\frac{{S}_{F}}{{S}_{D}} = {\{ \frac{tan ( {θ}_{f} / 2 )}{tan ( FOV / 2 )} \}}^{2} \qquad ( 23 )$$

resulting in only 0.6% of the total area. Therefore, in this embodiment, the overall power consumption can be reduced by approximately 40%, and compared to Comparative Example 1, the power can be reduced by 10% while maintaining the same brightness.

### Embodiment 7

This embodiment is identical to Embodiment 6 except for the following.

In this embodiment, the gamma characteristics of the displayed images are changed between the LF frame period and the non-LF frame period. This allows for independent optimization of the display state for LF3D images and 2D disparity images, further enhancing the formation of a high-quality 3D image space.

Additionally, during the LF frame period, LF is output only to the central visual field image region. This reduces the rendering load of unnecessary LF images and reduces the overall load, including 2D display, by approximately 40%.

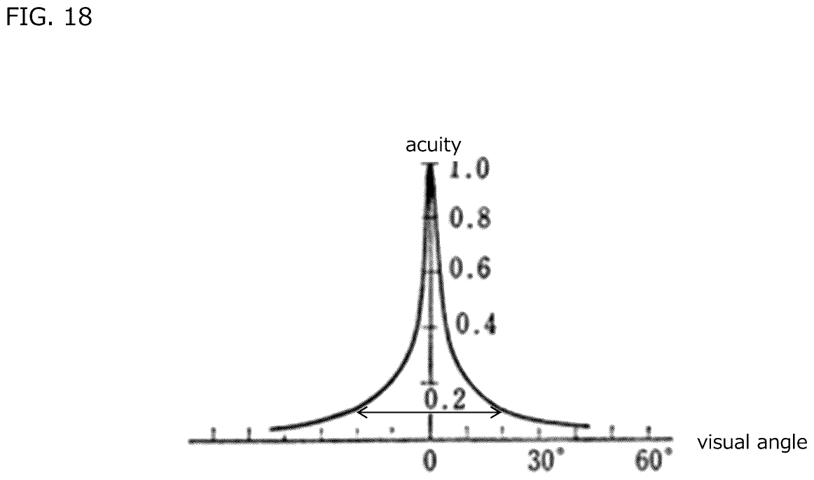

Furthermore, the visual acuity of the peripheral visual field with low information reception capability is approximately 0.05 to 0.3, averaging around 0.15. FIG. 18 shows the relationship between visual angle and visual acuity. Human visual acuity drops sharply outside the macular region, reaching about 0.5 at a visual angle of ±3°, about 0.3 at ±5°, about 0.2 at ±10°, and less than 0.1 beyond a visual angle of ±20°.

Therefore, the resolution of the 2D image region does not need to be equivalent to that of the fovea region and is sufficient at around 10 pixels per degree (PPD). In this embodiment, the resolution of 2D display is halved from 1440×1440 to 720×720 (same image information at 2 pixels x 2 pixels). This reduces the rendering load for 2D display to one-fourth, achieving a reduction in rendering load of approximately 55% compared to Embodiment 5 and 6.

As a result, it is now possible to support frame rates of up to 393 fps with the NVIDIA GeForce RTX 4090 and up to 307 fps with the RTX 4070, allowing smooth rendering even with the affordable RTX 4070 without any issues.

### Embodiment 8

This embodiment is identical to Embodiment 7 except for the following.

In this embodiment, as shown in FIG. 15, LF images output from the virtual display surface area 61 projected by the central visual field 51 and 2D disparity images output from the virtual display surface area 62 projected by the the peripheral visual field 52 are synthesized and displayed as a single frame of video. That is, the region projected onto the virtual display surface of the LF3D when projecting the central visual field angle range 51 is defined as the central visual field image region 61. LF3D images are displayed in the central visual field image region 61, while the remaining areas 62 display 2D disparity images without outputting LF rays.

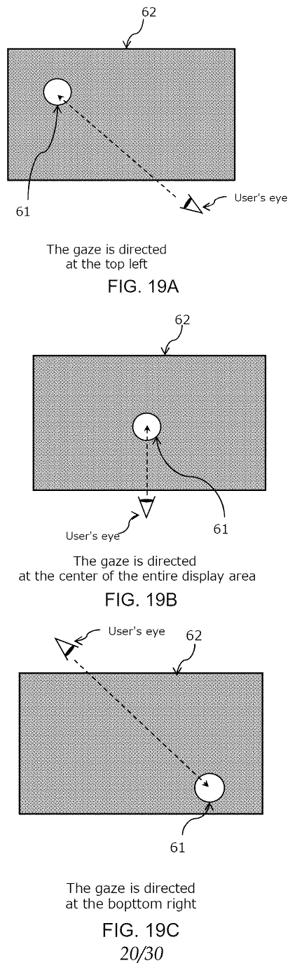

FIGS. 19A, 19B and 19C show an overview of image display in this embodiment. With a total field of view (FOV) of 60° and a total pixel count of 1440 pixels×1440 pixels, the central visual field image region 61 comprises 120 pixels×120 pixels. Note that it is sufficient for the region to be circular with a diameter of 120 pixels rather than square. Additionally, the aperture of the 2D image display region 62 of the light shutter is fully open.

Furthermore, as shown in FIGS. 19A, 19B and 19C, the position of the central visual field image region 61 is moved to match the user's line of sight. This movement is depicted in FIGS. 19A, 19B and 19C. The 2D image display region 62 display 2D images.

Thus, in this embodiment, effects similar to those from Embodiment 5 to 7 are achieved, including expanded FOV, crosstalk suppression, 3D resolution improvement, rendering load reduction, and power consumption reduction.

Additionally, unlike Embodiment 5 to 7, this embodiment does not require a non-LF display period, allowing the number of time divisions to be increased up to N×N, up to 6×6.

As a result, in this embodiment, the number of LF ray origins is increased to the equivalent of 246 (H)×246 (V), and the LF ray origin pitch nP can be reduced to 5.32 mm, resulting in a significant improvement in 3D resolution to 2.6×10\hat{ }5 points/m\hat{ }2, 1.7 times higher than the fifth embodiment and 1125 times higher than comparative example 1. Additionally, the total number of LF rays is increased to the equivalent of 36383 (H)×36383 (V), 1.2 times higher than the fifth embodiment.

Moreover, due to a further increase in the proportion of 2D display, a 40% reduction in power consumption compared to comparative example 1 was achieved when brightness was set to the same level.

Furthermore, as in Embodiment 6 and 7, combinations of local dimming control of the backlight, independent control of gamma characteristics, and reduction of resolution in the 2D display region are also within the scope of the present invention.

### Embodiment 9

This embodiment is identical to Embodiment 8 except for the following.

In this embodiment, a configuration is provided in which boundary image regions are gradually changed in LF emission angle width β, light beam divergence angle γ, and aperture density η at the boundary regions that exist in the peripheral areas of the central visual field (including discrimination visual field) image region 61 and serve as boundaries for 2D region.

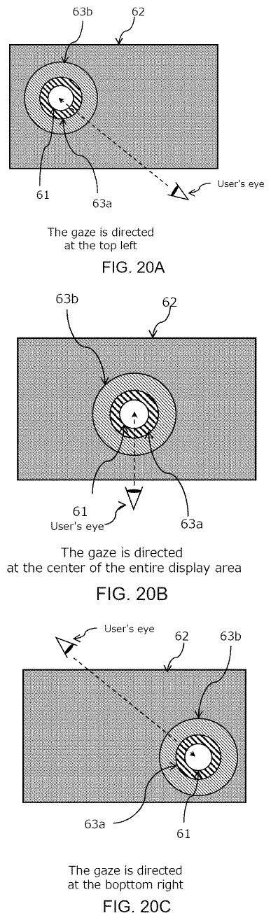

FIGS. 20A, 20B and 20C show a schematic diagram of the display method of the central visual field image region 61, 2D display region 62, and the two boundary image regions 63a and 63b in this embodiment. In this embodiment, as shown in FIGS. 20A, 20B and 20C, boundary image regions 63a and 63b are provided around the central visual field image region 61. While boundary image region 63a has LF output, boundary image region 63b is a 2D display region that does not output LF.

Boundary image region 63a reduces the brightness gap between the central visual field image region 61 and the 2D display region 62 by gradually increasing the size of the aperture n_{A}, i.e., the light beam divergence angle γ, from the central visual field image region 61 toward the two-dimensional image region 62, using the method shown in FIGS. 9A, 9B and 9C.

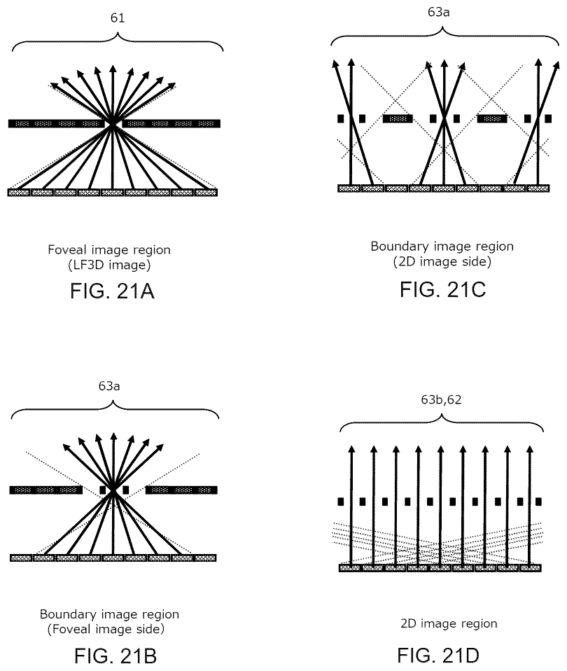

Moreover, to reduce the sensation of LF disappearance at the boundary of the central visual field image region 61 for 3D images, boundary image region 63a gradually approaches the ray state of the 2D image region, as shown in FIGS. 21A, 21B, 21C and 21D, by combining the methods shown in FIGS. 8A, 8B and 8C, and FIGS. 9A, 9B and 9C to change the area, number of display pixels n_{LF}(area), and aperture density, while reducing the number of LF rays N and LF emission angle β. Specifically, within boundary image region 63a, brightness gradually increases toward the 2D image display region 62, while the sharpness of 3D images decreases. Here, overall brightness adjustment is performed through local dimming of the backlight or gamma adjustment.

In this embodiment, boundary image region 63a is set to the region from ±2.5 (5°) to ±5° (10°). LF density is reduced to ¼ and aperture area is increased fourfold for the region from ±2.5 (5°) t to ±3.5° (7°), and LF density is reduced to 1/9 and aperture area is increased ninefold for the region from ±3.5 (7°) to ±5° (10°). The 2D image region is set for the region beyond ±5°.

On the other hand, boundary image region 63b is set to have higher resolution than the 2D display region 62, and the resolution of the 2D display area 62 is further reduced. Specifically, boundary image region 63b has set to 2 pixels×2 pixels representing one pixel, while 2D image region 62 has its resolution reduced to ⅖, with 5 pixels×5 pixels representing one pixel.

Additionally, in this embodiment, the position of each boundary is temporally varied, further reducing the prominence of the boundaries and creating a seamless, cohesive natural overall image.

As a result, the central visual field image region 61 and the 2D image region 62 can be seamlessly connected continuously, creating a natural overall image without discomfort. Other effects are the same as those of Embodiment 8. Furthermore, the further reduction in resolution of the 2D images reduces the rendering load, allowing for an even higher frame rate of the graphics board or enabling the use of a lower-cost graphics board.

Note that the setting of boundary values for boundary image region 63a and 63b in this embodiment is not limited to the condition of this embodiment, and setting with other condition is within the scope of the present invention. Additionally, either boundary image region 63a or boundary image region 63b may be used alone.

### Embodiment 10

This embodiment is identical to Embodiment 9 except for the following.

In this embodiment, a dedicated high-speed binary liquid crystal light shutter was realized and used as the light shutter panel. Additionally, a color OLED display panel was used as the display panel 2 instead of a liquid crystal display panel.

The response time(3τ)of the binary liquid crystal light shutter panel is 0.1 ms for both OFF to ON(T_{ON}) and ON to OFF(T_{OFF}) transitions. The response time(3τ)of the color OLED display panel is 0.05 ms for both T_{ON} and T_{OFF} transitions.

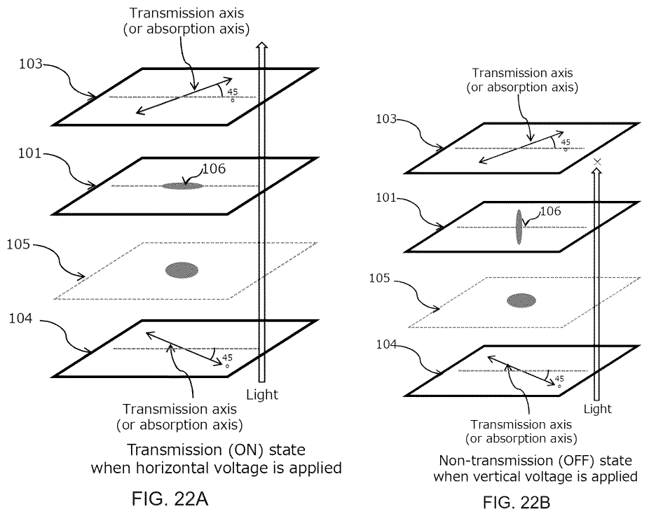

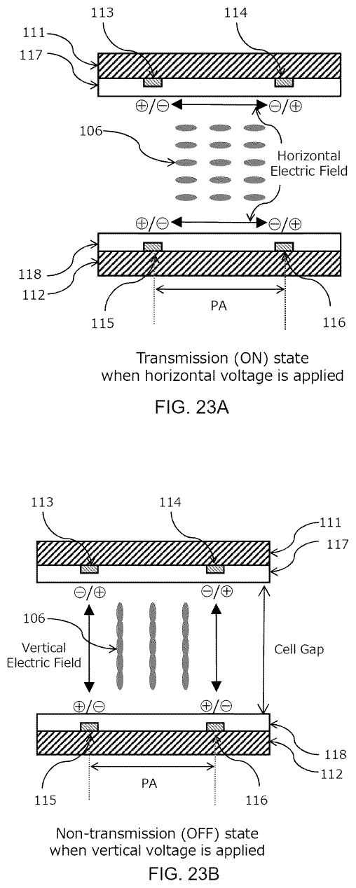

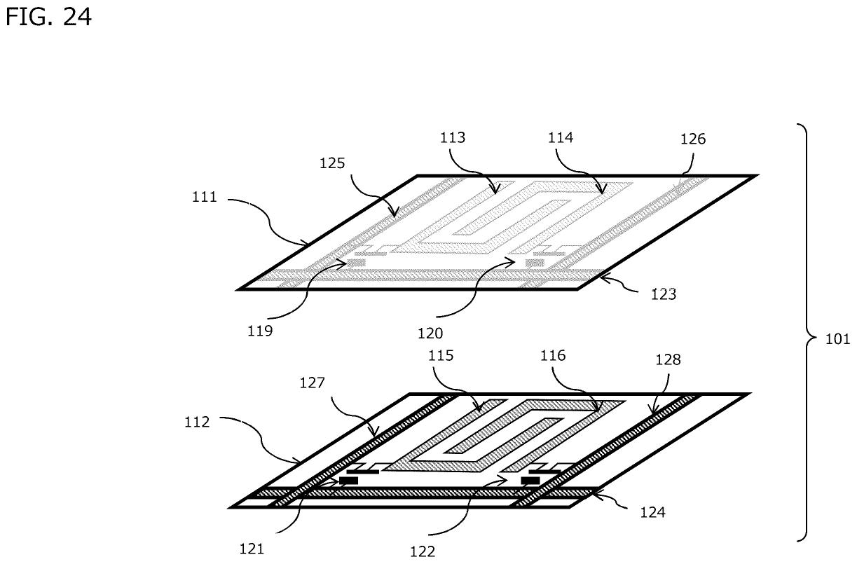

FIGS. 22A and 22B show the configuration and optical operation state of the high-speed liquid crystal optical shutter of this embodiment. FIGS. 23A and 23B show the cross-section of the liquid crystal cell and its electrical driving state. FIG. 24 depicts the pixel circuit and electrode arrangement of the liquid crystal cell.

Here, 101 represents the liquid crystal cell, 103 and 104 are a pair of polarizers arranged in cross-Nicol configuration, 105 is a retardation plate for compensating the viewing angle, 106 represents the liquid crystal molecules, 113, 114, 115, and 116 are electrode groups on the liquid crystal cell substrate 111 and 112, 117 and 118 are boundary layers consist of inorganic films 117 and 118, 120 and 121 are Thin-Film Transistors, 121 and 123 are scanning electrodes, and 125, 126, 127 and 128 are signal electrodes. The optical display principle of the liquid crystal cell is omitted, as it follows the general birefringence method.

As shown FIGS. 23A and 23B, The characteristic feature of the high-speed liquid crystal light shutter in this embodiment is the configuration of electrode groups 113, 114, 115, and 116 on the liquid crystal cell substrate 111 and 112 that can switch horizontal and vertical electric fields. This allows for driving with voltage application for both T_{ON} and T_{OFF} transitions. Particularly, the T_{OFF} response time, which depended on the anchoring force with the substrate, has been dramatically improved. A voltage is applied to each electrode 113, 114, 115, and 116 through thin-film transistors 119, 120, 121, and 122 from the scanning electrodes 121 and 123, and the signal electrodes 125, 126, 127, and 128.

Furthermore, In this embodiment, the liquid crystal cell 101 is characterized by forming inorganic films 117 and 118 at the interface with the liquid crystal molecules 106 without using alignment control layers such as alignment films typically used in conventional liquid crystal devices. Specifically, the inorganic film 118 is formed of a silicon oxide film. As a result, the anchoring force between the liquid crystal molecules 16 and the substrate, which adversely affects response speed, is minimized.

As a result, the contrast ratio has significantly improved from 10.9 to 163 in this embodiment. Other performance characteristics are equivalent to those of Embodiment 9.

Additionally, for improvement of contrast ratio, instead of using the light shutter array panel 1 in this embodiment, a light shutter using ferroelectric liquid crystal may be used, and there is no particular limitation on the type of high-speed transparent panel used, as long as it has a high response rate equal to 0.1 ms or less.

Moreover, a transparent (or semi-transparent) OLED panel may be used to achieve a see-through effect. However, the display panel 2 is not limited to OLED and may also be an LED display panel. Other displays with response times of tens of microseconds or less may also be used.

### Embodiment 11

This embodiment is identical to Embodiment 10 except for the following.

In this embodiment, control is performed to switch the display image on the display and the aperture pattern of the light shutter according to user information and video information.

VAC, which is an issue of the present invention, begins to be perceived from a visual distance of 0.4 D (2.5 m) or less. Therefore, LF3D images are not required for visual distances longer than this. Particularly, when the virtual image display surface 12 is set to around 2 m, VAC is not perceived up to a visual distance of 1 m. Hence, LF3D images are not necessary for visual distances greater than 1 m.

Typically, when focusing on an object, it often involves observing stationary objects, especially when performing detailed tasks. Thus, the demand for faithfully and finely viewing 3D images mostly occurs in situations where the visual distance is close and the object is in a nearly stationary state. Conversely, fast-moving videos, which do not allow focusing on objects, usually do not require faithful LF-based 3D images. Instead, for tasks such as spatial perception and self-motion recognition, a fast response rate in videos is preferable.

In this embodiment, a video is defined as an image that appears to move relative to the user's eyes. For instance, when tracking an object that is moving, it appears stationary, indicating a low degree of video. Conversely, even if the image itself is a still image, if the user's gaze is moving and not fixating on the object, the video degree is considered high.

Therefore, in this embodiment, a determiner is provided to determine the user's viewing distance L (the depth of focus Z) and the degree of video M based on user information and video information. Based on this determination, LF3D display and 2D parallax display are switched in real time.

Specifically, the viewing distance L and the degree of video M indicating the degree of movement of the image relative to the user's eyes are estimated from eye-tracking sensor data and input image data. Then, based on these estimations, the entire display or the image area of the central viewing field is switched between LF3D image and 2D parallax image.

Here, the depth of focus Z and the degree of video M are defined as follows:

$$L ( = Z ) = ( \frac{tan α1 \cdot tan α2}{tan α1 + tan α2} ) \cdot IPD \qquad ( 24 )$$

$$M = {\sum }_{ij} {( {P}_{ij}^{′} - {P}_{ij} )}^{2} / {\sum }_{ij} {P}_{ij}^{2} + κ \frac{\partial Z}{\partial t} \qquad ( 25 )$$

α1α2: Convergence Angle for Each of the Right and Left Eyes
IPS: Distance Between the User's Pupils
i,j: Coordinates of the Pixels Corresponding to the Central Visual Field
P′: Pixel Image Information from the Previous Frame
P: Pixel Image Information from the Current Frame
κ: Weighting Coefficient for the Degree of Motion against the Gaze

Additionally, the information from the head motion sensor is pre-reflected in the input image data in this embodiment.

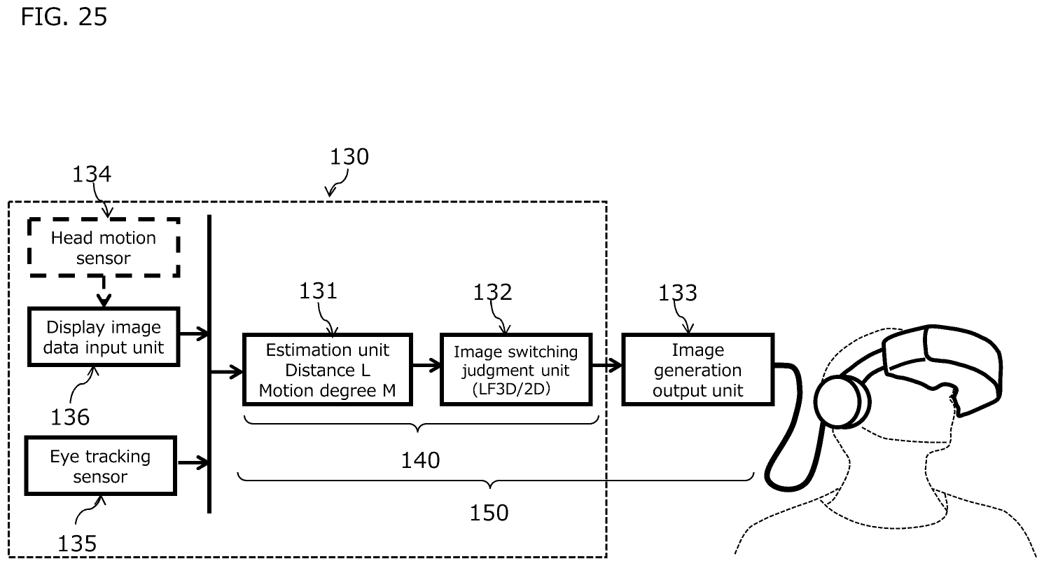

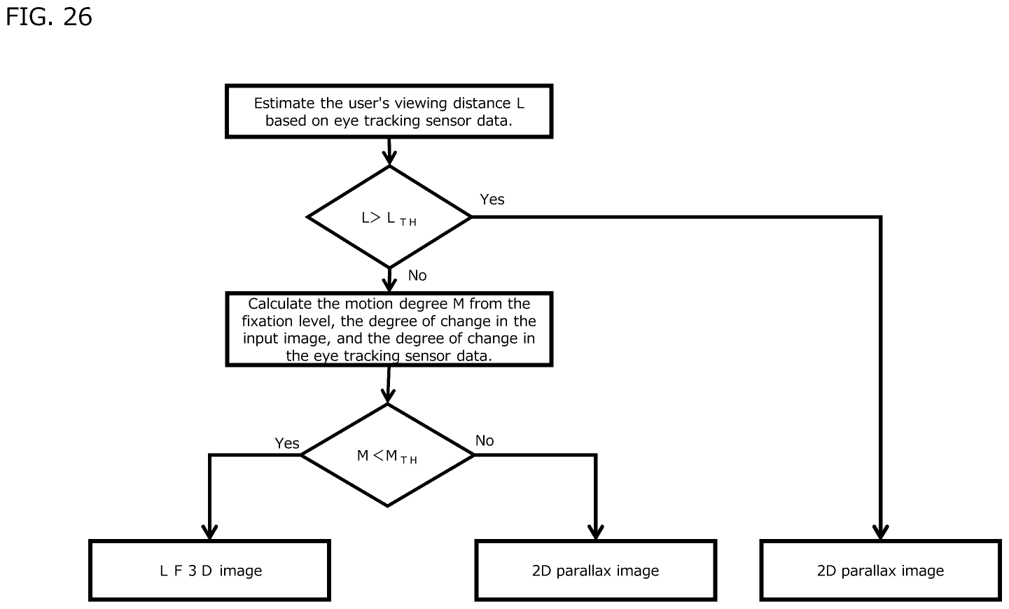

FIG. 25 illustrates the system configuration of the determiner in this embodiment, while FIG. 26 shows the flowchart for switching between LF3D images and 2D parallax images.

In FIG. 25, 130 represents the determiner consist of Estimation unit 131 of Distance L and Motion degree M, Image switching judgment unit (LF3D/2D) 132, Eye tracking sensor 135 and Display image data input unit 136. In some cases, it may also include a head motion sensor 134 and Image generation output unit 133.

Firstly, based on the eye-tracking sensor data, if the user is looking into the distance, i.e., when the viewing distance L is greater than a threshold L_{TH}, 2D parallax image display is activated.

Next, the degree of video M is calculated based on the changes in the input image and the eye-tracking sensor data. If the user is viewing slow-moving images, i.e., when the degree of video M is less than a threshold M_{TH}, LF3D images are displayed. Conversely, when displaying fast-moving images, i.e., when the degree of video M is greater than a threshold M_{TH}, the system switches to 2D parallax images.

In this embodiment, the threshold L_{TH} for viewing distance L is set to 1 m. Additionally, the threshold M_{TH} for the degree of video M is set to 0.1. Moreover, the priority order for control is:

Viewing distance L (the depth of focus Z)>Degree of video M.

Thus, in this embodiment, users can view high-resolution LF3D images when they need to focus on nearby objects for tasks, while they can view 2D parallax images for fast-moving videos or panoramic views. This allows for a combination of high-precision 3D images and video images, enhancing the perception of information reception capacity across the entire field of view. As a result, motion parallax when looking into the distance and the appearance of moving objects when tracking them with the eyes appear more natural, significantly reducing motion sickness.

Furthermore, in this embodiment, determination based on either viewing distance L or degree of video M alone is acceptable. Additionally, the priority order can be changed according to the specific application.

### Embodiment 12

This embodiment is identical to Embodiment 11 except for the following.

In this embodiment, the switching of the display image on the display and the aperture pattern of the light shutter, as performed in Embodiment 11, was implemented using a classifier 140 pre-trained with AI through machine learning as illustrated in FIG. 25.

Specifically, the optimal display image (teacher data) for the viewing distance L (focal length) and the degree of motion M is provided to the AI, along with the time division number N, the maximum LF radiation angle βmax, the aperture area n_{A}, and in the case of Embodiment 5 to 10, additionally the resolution of the 2D display, and in the case of Embodiment 8 to 10, further the optimal control parameters for the area of the 2D display are machine-learned. For obtaining the teacher data, real-time measurements such as EEG (electroencephalogram) and NIRS (near-infrared spectroscopy) data can also be used.

Then, real-time switching to display the optimal 3D images was performed based on AI classifiers 140 while inputting user information and video information for each display frame.

As a result, this embodiment not only achieves the effects of Embodiment 11 but also provides more finely optimized and natural 3D panoramic images tailored to human visual characteristics. Furthermore, discontinuities during switching, an issue in Embodiment 11, are improved, making the switching less perceptible.

### Embodiment 13

This embodiment is identical to Embodiment 12 except for the following.

In this embodiment, AI-based output unit 150 with the algorithm of the classifier used in Embodiment 12 as illustrated in FIG. 25, generating images for display panels and aperture patterns of light shutter panels for LF3D or 2D parallax images directly from conventional video formats, was created. In this embodiment, the AI-based output unit 150 can generate and output LF 3D display images and light shutter aperture patterns directly from conventional video formats instantaneously.

The AI created is based on a 2D convolutional neural network (CNN). For pre-training, the teacher data determined to be optimal by the user in Embodiment 12 was used, and the difference between this data and the output data created based on rendering up to Embodiment 12 was machine-learned.

The teacher data for training was created by showing subjects videos with artificially varied control parameters using the HMD of the present invention and obtaining evaluations for those videos. For obtaining the teacher data, real-time measurements such as EEG (electroencephalogram) and NIRS (near-infrared spectroscopy) data can also be used.

As a result, the complex rendering calculations required up to Embodiment 12 are simplified, and the rendering load is further reduced. This enables further reduction in power consumption or an increase in the number of time divisions, allowing for the provision of even higher resolution 3D images.

Additionally, this allows for the use of traditional format content with the HMD of the present invention without the need to create dedicated image data for the HMD of the invention. As a result, existing video assets can be utilized, enabling widespread adoption.

1. A light field image display device comprising:
a display panel having at least one group of element pixels consisting of a plurality of pixels displaying light field information;
an optical shutter array panel forming at least one aperture by opening and closing a plurality of optical shutters;
wherein the element pixel group and the aperture form a light field ray group with multiple emission angles;
an eye-tracking sensor configured to determine the user's viewpoint;
wherein, based on the viewpoint, the relative positions of the element pixel group and the aperture are changed to vary the angles of the light field ray group;
wherein the device includes at least one padding pixel group consisting of pixels that do not display the light field information around the periphery of the element pixel group.

2. The light field image display device according to claim 1, further comprising a high refractive member with a refractive index greater than 1 disposed between the display panel and the optical shutter array panel.

3. The light field image display device according to claim 1, wherein the element pixel group is arranged in a diamond shape, circular shape, elliptical shape, or concentric polygonal shape.

4. A light field image display device comprising:
a display panel having at least one group of element pixels consisting of a plurality of pixels displaying light field information;
an optical shutter array panel forming at least one aperture by opening and closing a plurality of optical shutters;
wherein the element pixel group and the aperture form a light field ray group with multiple emission angles;
an eye-tracking sensor configured to determine the user's viewpoint and a central viewing angle range determined from the viewpoint;
wherein the surface that serves as the origins for said light field ray group is divided into a first region, which is projected by said central viewing angle range, and at least one second region other than the first region;
wherein the light field ray group is output from only the first region, and a two-dimensional image is output from the second region.

5. The light field image display device according to claim 4, wherein the maximum emission angle of the light field ray group is in the range of 5° to 30°.

6. The light field image display device according to claim 4, wherein the display resolution of the two-dimensional image in the at least one second region is ½ to 1/10 of the resolution of the display panel.

7. The light field image display device according to claim 4, wherein the maximum brightness of the region corresponding to the first region on the display panel is controlled to be higher than the maximum brightness of the region corresponding to the at least one second region.

8. The light field image display device according to claim 4, wherein the gamma characteristics of the region corresponding to the first region on the display panel are controlled to be different from the gamma characteristics of the region corresponding to the at least one second region.

9. The light field image display device according to claim 4, comprising a plurality of display frames for updating the display image within a certain time period;
wherein the plurality of display frames are divided into a first group of display frames and a second group of display frames;
wherein the light field ray group is output in the first group of display frames, and the two-dimensional image is output in the second group of display frames.

10. The light field image display device according to claim 9, wherein the apertures of the optical shutter array panel corresponding to the second region are all closed in the first group of display frames, and the apertures of the optical shutter array panel corresponding to the first region are all closed in the second group of display frames.

11. The light field image display device according to claim 4, wherein the first region comprises a central region and at least one boundary region divided concentrically or in a concentric polygonal shape;
wherein the outer periphery of the boundary region is adjacent to the at least one second region on the surface of the light field ray group origins;
wherein the beam divergence angle of the light field ray group in the at least one boundary region is wider than that in the central region, and the number of light rays in the light field ray group in the at least one boundary region is smaller than that in the central region.

12. The light field image display device according to claim 11, wherein the position of the boundary line where the at least one boundary region and the at least one second region contact each other changes over time.

13. The light field image display device according to claim 4, wherein the surface of the light field ray group origins is a virtual image display surface of said display panel magnified by the eyepiece lens.

14. A light field image display device comprising:
a display panel having at least one group of element pixels consisting of a plurality of pixels displaying light field information;
an optical shutter array panel forming at least one aperture by opening and closing a plurality of optical shutters;
wherein the element pixel group and the aperture form a light field ray group with multiple emission angles;
further comprising an eye-tracking sensor, and at least one of the following:
means for estimating a user's viewing distance L based on the eye-tracking sensor data; and means for estimating a degree of motion M of the image relative to the user's eye based on the eye-tracking sensor data and input image data.

15. The light field display device according to claim 14, wherein the entire display area is switched to a two-dimensional image display if at least one of the following conditions is met: the viewing distance L is greater than 1 meter, or the degree of motion M exceeds a threshold M_{TH}.

16. The light field image display device according to claim 14, wherein the number of light rays, absolute angle, emission angle width, divergence angle, position of the origin, and density of the origins of the light field ray group are varied for each display frame based on the viewing distance L and the motion degree M.

17. The light field image display device according to claim 14, wherein a two-dimensional convolutional neural network is used to generate, for each display frame, the display image of the display panel and the aperture pattern of the optical shutter array panel from the input image data, the viewing distance L, and the motion degree M.

18. The light field image display device according to claim 1, wherein the optical shutter array panel comprises:
a liquid crystal cell consisting of a pair of opposed substrates and a liquid crystal layer sandwiched between them;
at least one polarizer; and
an electrode group capable of switching between applying a horizontal electric field and a vertical electric field to the liquid crystal layer;
wherein the aperture is varied by partially changing the orientation state of the liquid crystal layer with the electric field applied by the electrode group and switching the opening and closing of each of the plurality of optical shutters.

19. The light field image display device according to claim 1, wherein the resolution of the emission angle of the light field ray group is 0.3° or less.

20. A display device using the light field image display device as recited in claim 1, wherein the display device is selected from the group consisting of a head-mounted display, a direct-view flat panel display, and a digital microscope.
